(19) United States
(12) Patent Application Publication
(10) Pub. No.: US 2026/0201178 A1
(43) Pub. Date: Jul. 16, 2026

(54) AQUEOUS INTERPENETRATING POLYMER NETWORK

(71) Applicants: THE UNIVERSITY OF SYDNEY, Sydney, New South Wales (AU); THE AUSTRALIAN NATIONAL UNIVERSITY, Acton, Australian Capital Territory (AU)

(72) Inventors: Antonio TRICOLI, Sydney, New South Wales (AU); David NISBET, Canberra, Australian Capital Territory (AU); Puneet GARG, Canberra, Australian Capital Territory (AU)

(21) Appl. No.: 19/136,697

(22) PCT Filed: Dec. 8, 2023
(86) PCT No.: PCT/AU2023/051276

§ 371 Date: Jun. 6, 2025

(30) Foreign Application Priority Data
Dec. 9, 2022 (AU) 2022903771

(51) Int. Cl. C09D 5/16; C09D 133/12; C09D 175/12

(52) U.S. Cl. CPC C09D 5/1668; C09D 133/12; C09D 175/12

(57) ABSTRACT

The present invention is directed to a process for making a sprayable aqueous colloidal suspension, wherein the colloidal suspension comprises an interpenetrating polymer network and the interpenetrating polymer network comprises a polyurethane network and a polyacrylic network, the process comprising the steps: a) preparing a polyurethane prepolymer composition by mixing, at a reaction temperature between about 50° C. and about 120° C.: i. an aliphatic isocyanate having at least two isocyanate groups per molecule; ii. a diol; iii. a polyol having at least one acid group per molecule; and iv. a polyurethane polymerization catalyst; b) cooling the polyurethane prepolymer composition to a temperature less than the reaction temperature and then adding an alkyl amine to form a neutralized polyurethane prepolymer composition; then c) adding to the neutralized polyurethane prepolymer composition, with mixing: i. water; ii. a polyurethane chain extender, iii. A crosslinking acrylic monomer; and iv. a free radical initiator wherein a non-crosslinking acrylic monomer is also added in step b) or step c), to form the aqueous colloidal suspension.

### RELATED APPLICATION

This application claims priority from Australian Provisional Patent Application No. 2022903771 filed on 9 Dec. 2022, the entire contents of which are incorporated herein by reference.

### FIELD

The invention relates to sprayable aqueous dispersions of interpenetrating polymer networks and to films or coatings formed therefrom.

### BACKGROUND

Surfaces treated with a superhydrophobic coating or film have shown significant promise as next-generation self-cleaning surfaces. Superhydrophobic surfaces can be used in a number of applications, including as an anti-corrosion treatment, preventing moisture degradation in composite materials, preventing bio-fouling of surfaces regularly submerged in water, in oil-water separation processes, drag reduction and anti-icing coatings and recently, as anti-viral and anti-bacterial surfaces.

Superhydrophobic coatings have been an active area of research for the past two decades, however they are yet to realise their commercial potential, despite the effort spent in attempting to do so. Generally, the commercialisation of superhydrophobic surfaces has been hindered by poor mechanical durability and the use of hazardous chemicals in the fabrication process. Whilst ultra-robust superhydrophobic coatings with excellent abrasion resistance based on interpenetrating polymer networks (IPNs) are now achievable, IPNs still rely on organic solvents such as acetone and xylene in their synthesis, which are characterised as volatile organic compounds (VOCs) by both European and US environment protection agencies. Not only do VOCs pose environmental and health hazards for employees at manufacturing facilities, but manufacturing costs are also significantly increased to avoid the release of VOCs into the environment and to meet various strict health and safety requirements.

Further, the commercialisation potential of superhydrophobic coatings may be increased if the method of forming the coating was improved. Currently, IPN-based coatings are generally formed by a casting process, whereby the IPN dispersion, or precursors to the two polymer systems, are poured onto a surface which, upon drying and/or curing (which may include a heating step), forms a coating. However, not all surfaces or materials are suitable for this process. For example, external aircraft panels (which may benefit from a superhydrophobic coating for its de-icing properties) may not be suitable for heating (due to the materials used) or too large to heat without specialist equipment, or of a convex shape that does not allow for casting. Although alternative processes such as spraying can improve the application of a superhydrophobic coating to many surfaces, it is a known problem that IPN synthesis is sensitive to full gelation (which is undesirable when attempting to achieve a sprayable dispersion) and obtaining a sprayable dispersion of IPN particles can be difficult to achieve.

Accordingly, there is a need for an environmentally friendly superhydrophobic coating formulation comprising an IPN in an aqueous dispersion that still maintains high mechanical resistance and excellent abrasion resistance but is low in pollutants. Preferably, the environmentally friendly superhydrophobic coating formulation would be sprayable to allow for easier application of the coating to a wider range of surface materials. It is also preferred that the aqueous dispersion can dry at ambient conditions to form a coating on a surface.

It is an object of the present invention that at least one of the needs above is at least partially satisfied.

It is an object of the present invention to overcome or ameliorate one or more the disadvantages of the prior art, or at least to provide a useful alternative.

### SUMMARY OF INVENTION

The present invention aims to reduce the use of pollutants, and particularly volatile organic solvents, commonly used to produce polymer-based coatings. In particular, the present invention aims to provide a process for producing an aqueous-based interpenetrating polymer network dispersion that is capable of forming a superhydrophobic coating, that is preferably robust and/or durable and is at least comparable to a coating formed from an organic solvent-based interpenetrating polymer network dispersion.

In a first aspect of the present invention, there is provided a process for making a sprayable aqueous colloidal suspension, wherein the colloidal suspension comprises an interpenetrating polymer network and the interpenetrating polymer network comprises a polyurethane network and a polyacrylic network, the process comprising the steps:
a) preparing a polyurethane prepolymer composition by mixing, at a reaction temperature between about 50° C. and about 120° C.:
i. an aliphatic isocyanate having at least two isocyanate groups per molecule;
ii. a diol;
iii. a polyol having at least one acid group per molecule; and
iv. a polyurethane polymerization catalyst;
b) cooling the polyurethane prepolymer composition to a temperature less than the reaction temperature and then adding an alkyl amine and a dispersion medium to form a neutralized polyurethane prepolymer composition, wherein the dispersion medium is selected from water or a non-crosslinking acrylic monomer; then
c) adding to the neutralized polyurethane prepolymer composition, with mixing:
i. water if the dispersion medium of step b) is a non-crosslinking acrylic monomer, or a non-crosslinking acrylic monomer if the dispersion medium of step b) is water;
ii. a polyurethane chain extender,
iii. a crosslinking acrylic monomer; and
iv. a free radical initiator
to form the aqueous colloidal suspension.

The following options may be used in combination with the first aspect, either individually or in any suitable combination.

The aliphatic isocyanate of the process of the present invention may comprise an aliphatic diisocyanate or an aliphatic triisocyanate. Preferably, the isocyanate is an aliphatic diisocyanate. More preferably, the isocyanate is isophorone diisocyanate (IPDI).

The process of the first aspect of the present invention utilises a polyol that has been substituted with at least one acid group per molecule. The acid group will replace a hydroxyl group. It may be a triol, a tetraol or a pentaol that has at least one hydroxyl group substituted with an acid group. The acid group may be any suitable ionizable acid group, such as for instance, a carboxyl group, a sulphate group, a phosphate group or a nitrate group. Preferably, the polyol has one carboxylic acid group per molecule. More preferably, the polyol is 2,2-bis(hydroxymethyl)propionic acid (DMPA).

The process of the first aspect of the present invention also utilizes a diol, being an organic moiety with two hydroxyl groups. The hydroxyl groups may be terminal hydroxyl groups (that is, located at the end of the longest organic chain). The diol may be oligomeric or polymeric. It may be an oligomeric or polymeric glycol. Preferably, the diol is a polyether glycol. More preferably, the diol is a poly(tetramethylene ether) glycol.

The polyurethane polymerization catalyst of the present invention may be any suitable catalyst capable of initiating polyurethane polymerization. Preferably, the polyurethane catalyst is dibutyltin dilaurate.

The alkyl amine of the first aspect is added to neutralize the acid groups provided by the acid substituted polyol. The alkyl amine may be a dialkylamine or a trialkylamine. Preferably, the alkyl amine is a trialkylamine. More preferably, the trialkylamine is triethylamine (TEA).

The polyurethane chain extender of the first aspect of the present invention may be any suitable compound capable of reacting with the NCO-terminated polyurethane prepolymers. It may comprise at least one hydroxyl group, or at least one amine group, or a combination thereof. The skilled person would understand that the chain extender must have at least two groups capable of reacting with an isocyanate group in order to form crosslinks. It may be a diol, a polyol, a diamine, a triamine or a tetramine. It may be the same diol or polyol described herein or it may be different. In one preferred embodiment, it may be a diamine, a triamine or a tetramine. Preferably, it is a triamine. More preferably, the triamine is diethylenetriamine (DETA).

The first aspect of the present invention also comprises a non-crosslinking acrylic monomer, a crosslinking acrylic monomer and a free radical initiator. The non-crosslinking acrylic monomer may be an acrylate ester or a methacrylate ester. Preferably, the non-crosslinking acrylic monomer is a methacrylate ester. More preferably, the non-crosslinking acrylic monomer is methyl methacrylate. The crosslinking acrylic monomer may be a diol di(meth)acrylate, a triol tri(meth)acrylate, a tetraol tetra(meth)acrylate or a pentaol penta(meth)acrylate. Preferably, the crosslinking acrylic monomer is a triol tri(meth)acrylate. More preferably, the crosslinking acrylic monomer is trimethylolpropane trimethacrylate (TRIM). The free radical initiator may be any suitable initiator that is capable of initiating an acrylic polymerization reaction. In one preferred embodiment, it is 2,2′-azobis(2-methylpropionitrile) (AIBN).

The inventors consider that the relative ratios of certain reactants contribute to the advantages of the present invention. Preferably, the inventors have found that the following relative molar ratios are most significant in producing a stable aqueous dispersion as described herein:
an aliphatic isocyanate to a diol of between 1:1 and 5:1, or between about 2:1 and 3:1, particularly 3:1;
an aliphatic isocyanate to a polyol having at least one acid group per molecule of between 2:1 and 6:1, particularly 4:1;
an aliphatic isocyanate to total hydroxyl groups (that is, the sum of a polyol and a diol) of between 1:1 and 2:1, particularly about 1.4:1;
a non-crosslinking monomer to a crosslinking monomer of between 10:1 and 50:1;
a polyol having at least one acid group per molecule to a diol of between 1:1 and 10:1, particularly between 6:1 and 8:1;
total pendent acid groups to alkyl amine of about 1:1; and
hard segment (that is, the sum of an aliphatic isocyanate, a polyol having at least one acid group per molecule and a polyurethane chain extender) to soft segment (that is, a diol) of between 1:2 and 1:20, particularly 1:3 and 1:5.

The reaction temperature of step a) of the first aspect may be between about 50° C. and about 120° C., or between about 70° C. and about 100° C., or between about 80° C. and 90° C., such as about 50, 55, 60, 65, 70, 75, 80, 85, 90, 95, 100, 105, 110, 115 or 120° C. or any range therein. In one preferred embodiment, the reaction temperature is about 90° C.

The process of the first aspect may further comprise a waiting time between step a) and b). In other words, once the reactants of step a) are mixed and heated to the reaction temperature, the composition may be held at this reaction temperature for a period of time to ensure complete, or at least sufficient, reaction to occur. The waiting or reaction time may be between about 2 hour and about 6 hours, or between about 2 hour and 4 hours, or between 3 hours and 5 hours, such as about 2, 2.5, 3, 3.5, 4, 4.5, 5, 5.5 or 6 hours or any range therein. In one embodiment, the reaction time is about 4 hours. Similarly, the process of the first aspect may further comprise a waiting time between step b) and step c) of between about 10 minutes and about 1 hour, or between about 20 minutes and 40 minutes, or between about 25 minutes and 50 minutes, such as about 10, 5, 20, 25, 30, 35, 40, 45, 50, 55 or 60 minutes. Similarly, the process of the first aspect may further comprise a waiting time after step c) before application of the sprayable aqueous colloidal suspension of at least 2 hours, such as between about 4 hour and 24 hours, or between about 2 hours and 12 hours, or between about 6 hours and about 12 hours, such as about 2, 3, 4, 5, 6, 7, 8, 9, 10, 11, 12, 13, 14, 15, 16, 17, 18, 19, 20, 21, 22, 23 or 24 hours.

The colloidal dispersion formed from the process of the first aspect is advantageously sprayable. That is, the dispersion may be suitable to be applied to a surface via a spraying apparatus. As such, the sprayable dispersion should not comprise any large agglomerations that would not be able to pass through a spraying apparatus. Although the dispersion may be sprayable, this does not preclude the dispersion from being able to be applied using other means known in the art, such as casting, rolling, spin coating or the like.

Accordingly, in one embodiment of the present invention, there is provided a process for making a sprayable aqueous colloidal suspension, wherein the colloidal suspension comprises an interpenetrating polymer network and the interpenetrating polymer network comprises a polyurethane network and a polyacrylic network, the process comprising the steps:
a) mixing isophorone diisocyanate, a polyether glycol, 2,2-bis(hydroxymethyl)propionic acid (DMPA) and a polyurethane catalyst, heating to a temperature of between 70° C. and 90° C. and holding at this temperature with mixing for about 4 hours to form a polyurethane prepolymer composition;
b) cooling the polyurethane prepolymer composition to a temperature of between about 50° C. and 60° C. and then adding a trialkylamine, a methacrylate ester and water to form a neutralized polyurethane prepolymer composition; and
c) adding to the neutralized polyurethane prepolymer composition a triamine, a methyl methacrylate and 2,2′-azobis(2-methylpropionitrile) (AIBN) with mixing, to form the aqueous colloidal suspension.

In another embodiment of the present invention, there is provided a process for making a sprayable aqueous colloidal suspension, wherein the colloidal suspension comprises an interpenetrating polymer network and the interpenetrating polymer network comprises a polyurethane network and a polyacrylic network, the process comprising the steps:
a) mixing an aliphatic diisocyanate, a poly(tetramethylene ether) glycol, 2,2-bis(hydroxymethyl)propionic acid (DMPA) and a polyurethane catalyst, heating to a temperature of about 90° C. and holding at this temperature with mixing for between about 3 and 5 hours to form a polyurethane prepolymer composition;
b) cooling the polyurethane prepolymer composition to a temperature of less than or about 60° C. and then adding triethylamine, methyl methacrylate and water to form a neutralized polyurethane prepolymer composition; and
c) adding to the neutralized polyurethane prepolymer composition a triamine, trimethylolpropane trimethacrylate and 2,2′-azobis(2-methylpropionitrile) (AIBN) with mixing, to form the aqueous colloidal suspension.

In another embodiment of the present invention, there is provided a process for making a sprayable aqueous colloidal suspension, wherein the colloidal suspension comprises an interpenetrating polymer network and the interpenetrating polymer network comprises a polyurethane network and a polyacrylic network, the process comprising the steps:
a) mixing an aliphatic diisocyanate, a poly(tetramethylene ether) glycol, 2,2-bis(hydroxymethyl)propionic acid (DMPA) and a polyurethane catalyst, heating to a temperature of about 90° C. and holding at this temperature with mixing for between about 3 and 5 hours to form a polyurethane prepolymer composition;
b) cooling the polyurethane prepolymer composition to a temperature of less than or about 60° C. and then adding triethylamine to form a neutralized polyurethane prepolymer composition; and
c) adding to the neutralized polyurethane prepolymer composition methyl methacrylate, water, a triamine, trimethylolpropane trimethacrylate and 2,2′-azobis(2-methylpropionitrile) (AIBN) with mixing, to form the aqueous colloidal suspension.

In a second aspect of the present invention, there is provided a process for making a coating comprising an interpenetrating polymer network, the process comprising the steps of:
a) spraying the aqueous colloidal suspension of the first aspect on to a surface to produce a coated surface; and
b) applying a particulate solid to the coated surface, wherein substantially the entire surface of the particulate solid is hydrophobic.

The following options may be used in combination with the second aspect, either individually or in any suitable combination

In a preferred embodiment, the applying of the particulate solid is by spraying, although other suitable application methods may be used.

The process of the second aspect may further comprise a period of time between applying the aqueous colloidal suspension to produce a coated surface and applying a particulate solid to the coated surface. This period of time may allow the coated surface to partially dry, allowing for improved adhesion between the coated surface and the particulate solid compared to immediate application of the particulate solid to the coated surface. As the skilled person would appreciate, the time taken for the coated surface to at least partially dry may be dependent in a range of environmental factors, including for example the temperature and humidity of the area that the coating is dried in, air flow and/or the presence of direct sunlight. Accordingly, the period of time required may be variable. In some embodiments, the period of time may be between about 1 minutes and about 240 minutes, such as between about 1 minute and 60 minutes, or between about 5 minutes and 30 minutes, or between about 10 minutes and 75 minutes, or between about 30 minutes and 90 minutes, or between about 40 and about 100 minutes, or between about 60 and 90 minutes, or between about 60 and 75 minutes, such as about 1, 2, 3, 4, 5, 6, 7, 8, 9, 10, 15, 20, 25, 30, 35, 40, 45, 50, 55, 60, 65, 70, 75, 80, 85, 90, 95 100, 110, 120, 130, 40, 150, 160, 170, 180, 190, 200, 210, 220, 230 or 240 minutes. In other embodiments, a longer period of time may be required. The particulate solid applied to the coated surface may be at least partially embedded in the coated surface, that is, at least a portion of the particulate solid is not wetted by the coated surface and is accessible at the surface. In some embodiments the particulate solid may be substantially embedded in the surface or entirely embedded in the surface.

In a third aspect of the present invention, there is provided a coating produced from the process of the second aspect.

### BRIEF DESCRIPTION OF DRAWINGS

Embodiments of the present invention will now be described, by way of example only, with reference to the accompanying figures.

FIG. 1 shows an aqueous PU-PMMA IPN system that has formed non-sprayable aggregations.

FIG. 2 shows a stable aqueous PU-PMMA IPN system that remains dispersed in an aqueous environment.

FIG. 3 shows an aqueous polyurethane system that has formed non-sprayable aggregations.

FIG. 4 shows result of an optimization study of spray volume and spray distance for APUA system to fabricate durable coatings: (a, b) change in optical transmission of coatings with hard abrasion; and (c, d) change in percent haze values as a function of abrasion cycles.

FIG. 5 shows the abrasion performance of the aqueous PU-PMMA IPN coating conducted using a rotary platform abrasion tester with two abrasive CS-10 (Calibrase, U.S.A) wheels (resurfaced with 150 grit discs) at 60 RPM based on the ASTM D4060 Taber standard. The load on each grinding wheel was 250 g.

FIG. 6 shows a Fourier-transform infrared (FTIR) spectrum comparing the aqueous suspension described herein with a solvent-based formulation in both a) uncured dispersion and b) cured coating.

FIG. 7 shows time-based reaction analysis of aqueous poly(urethane-acrylate): (a, b, & c) spectroscopic plots depicting the comparative analysis of APUA system at 0 h, 2 h, and 8 h time intervals; (d, e, & f) relative intensities indicating the decrease of intermediary water-isocyanate linkages, utilization of diethylenetriamine and decrease of free amine, and formation of long chains and cross-linking in the APUA system, respectively with time.

FIG. 8 shows superhydrophobic performance of APUA-F—SiO₂ coatings for varying APUA curing times evaluated via: (a) hard abrasion, and (b) soft abrasion.

FIG. 9 shows a comparative aqueous polyurethane system that has formed a non-sprayable gel.

### DEFINITIONS

The following abbreviations are used in the present specification:
AIBN: 2,2′-azobis(2-methylpropionitrile)
APUA: aqueous poly(urethane-acrylate) system
DBTDL: dibutyltin dilaurate
DETA: diethylenetriamine
DMPA: 2,2-bis(hydroxymethyl)propionic acid
IPDI: isophorone diisocyanate
IPN: interpenetrating polymer network
MMA: methyl methacrylate
PMMA: polymethyl methacrylate
POLYOL: polytetramethylene ether glycol (also, PolyTHF)
PU: polyurethane
SHS: superhydrophobic surface
TEA: triethylamine
TRIM: trimethacrylate
VOC: volatile organic compound

The following definitions are provided to enable the skilled person to better understand the invention disclosed herein. These are intended to be general and are not intended to limit the scope of the invention to these terms or definitions alone. Unless defined otherwise, all technical and scientific terms used herein have the same meaning as commonly understood by one having ordinary skill in the art to which the invention pertains.

The term “alkyl” as used herein refers to a hydrocarbon radical derived from an alkane, which may be linear, branched or cyclised. For instance, “methyl” refers to a radical group derived from methane.

The term “alkenyl” as used herein refers to a hydrocarbon radical derived from an alkene, which may be linear, branched or cyclised. For instance, “ethenyl” refers to a radical group derived from ethene.

The term “interpenetrating polymer network” as used herein refers to a “polymer comprising two or more networks which are at least partially interlaced on a molecular scale but not covalently bonded to each other and cannot be separated unless chemical bonds are broken” (see IUPAC Gold Book http://goldbook.iupac.org/I03117.html which is incorporated herein by reference in its entirety). It would be appreciated by the skilled person that the interlacing of networks generally requires both networks to formed in the presence of the other (either simultaneously or sequentially). The skilled person would also appreciate that the mixture of two or more pre-formed polymer networks is not an IPN but may be described as a polymer blend. Likewise, the skilled person would appreciate that a polymer material comprising one polymer network and one or more linear or branched polymer(s), whereby the polymer network is penetrated on a molecular scale by at least a portion of the linear or branched polymer(s), is not an IPN, but is rather described as semi-interpenetrating polymer network. Semi-interpenetrating polymer networks can, at least in principle, be separated into a polymer network and linear or branched polymer(s), which distinguish these from true IPNs, which cannot be separated without cleaving chemical bonds.

The term “network” (when applied to a polymer chain or system) or “polymer network” as used herein, refers to a polymer system (which may be linear or branched) that comprises intramolecular or intermolecular covalent bonds. These covalent bonds may be referred to as cross-links or cross-linkages and connects at least a portion of the polymer system to itself to form a network. The cross-linkages may form within a single polymer chain (i.e. intramolecular) or between identical polymer chains (i.e., intermolecular). As would be evident to the skilled person, a “polymer network” comprising at least a portion of cross-links will generally be “thermosetting” (that is, once formed and cured, a thermoset polymer will no longer melt or flow upon reheating) as the covalent cross-links can only be broken by breaking chemical bonds. On the other hand, linear or branched polymer chains tend to be thermoplastic (that is, a thermoplastic will melt or flow above the glass transition temperature, will solidify under the glass transition temperature, and can be reheated and cooled multiple times) as there are no permanent bonds between the polymer chains.

The term “polyacrylate” as used herein refers to a polymer chain or network formed from monomers comprising a C═C—C═O structure (i.e., formed from acrylate monomers, which are monomers comprising a moiety of structure C═C—C═O).

The term “polyurethane” as used herein refers to a polymer chain or network formed from organic units joined by divalent carbamate (or urethane) linkages of a —NH—(C═O)—O— structure.

The term “superhydrophobic” as used herein refers to a material surface with a water contact angle of at least 150°.

The terms “colloid”, “colloids”, “colloidal” or “colloidal suspension”, as used interchangeably herein, refer to a mixture in which one substance consisting of microscopically dispersed insoluble particles is suspended throughout another substance. For example, microscopic particles comprising a polymer-based system, such as an IPN, may be dispersed throughout a liquid, such as water.

As used herein, the term “comprising” means “including”. Variations of the word “comprising”, such as “comprise” and “comprises”, have correspondingly varied meanings. As used herein, the terms “including” and “comprising” are non-exclusive. As used herein, the terms “including” and “comprising” do not imply that the specified integer(s) represent a major part of the whole.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of”. In other words, with respect to the terms “comprising”, “consisting of”, and “consisting essentially of”, where one of these three terms are used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be non-restrictive regarding the number of instances (i.e., occurrences) of the element or component. Therefore “a” or “an” should be read to include one or at least one, and the singular word form of the element or component also includes the plural unless the number is obviously meant to be singular.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The terms “predominantly” and “substantially” as used herein shall mean comprising more than 50% by weight, unless otherwise indicated.

As used herein, with reference to numbers in a range of numerals, the terms “about”, “approximately” and “substantially” are understood to refer to the range of −10% to +10% of the referenced number, preferably −5% to +5% of the referenced number, more preferably −1% to +1% of the referenced number, most preferably −0.1% to +0.1% of the referenced number. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

As used herein, “wt. %” refers to the weight of a particular component relative to total weight of the referenced composition. Likewise, “% v/v” refers to the volume of a particular component relative to the volume of the referenced composition.

The complete disclosures of the patents, patent documents and publications cited herein are incorporated by reference in their entirety as if each were individually incorporated.

### DESCRIPTION OF EMBODIMENTS

The following description conveys exemplary embodiments of the present invention in sufficient detail to enable those of ordinary skill in the art to practice the present invention. Features or limitations of the various embodiments described do not necessarily limit other embodiments of the present invention or the present invention as a whole. Hence, the following detailed description does not limit the scope of the present invention, which is defined only by the claims.

The present invention described herein relates to an improved process for forming a superhydrophobic coating. More specifically, the present invention relates to a process for forming a superhydrophobic coating comprising an IPN. Generally, polymer-based coatings (including IPN-based coatings) are produced by dispersing the polymer (or monomers or precursors or particles thereof) in an organic solvent, whereby the organic solvent is generally classed as a VOC. This is particularly the case with hydrophobic polymers, such as polyurethanes, which are not readily dispersible in aqueous environments. With increasing global regulation of VOC's causing processes that utilise VOC's to become more expensive, the inventors have developed a process that eliminates, or at least substantially reduces, the use of VOC's in IPN-based polymer coating processes.

The inventors have previously described a process that utilises organic solvents to form a colloidal suspension of IPN particles which, when applied to a surface as a coating, renders that surface superhydrophobic (WO 2017/193157 A1, herein incorporated in its entirety by reference). As will be evident from the description below, the aqueous-based IPN of the present invention represents a significant improvement over this prior method, as the organic solvents (namely m-xylene and acetone) have been effectively replaced by water, thereby providing an improved process via the elimination, or substantial reduction, of VOCs. Advantages of the improved process of the present invention include reduced costs due to a decrease in solvent costs and VOC release mitigation requirements, improved health outcomes and a lower likelihood of adverse outcomes for manufacturing workers, and decreased impacts on the environment from VOC releases, which contribute to carbon levels in the atmosphere.

### Colloidal Dispersion

In order to produce a superhydrophobic coating, one approach includes an initial step of forming a colloidal dispersion (or, interchangeably, a suspension), whereby the colloidal particles comprise, or consist of, or consist essentially of, an IPN. Theoretically, any two or more cross-linkable polymer networks may be used to form the colloidal IPN particles. However, in a particularly preferred embodiment, the colloidal IPN particles comprise, or contain, or essentially contain, two polymer networks: one polymer network based on urethane linkages (that is, a polyurethane) and a polymer network based on acrylic or methacrylic monomers (that is, a polyacrylate or a polymethacrylate). The two polymer networks are interlaced on a molecular scale, or at least partially interlaced on a molecular scale. By “interlaced”, it is intended that the two polymer networks (the polyurethane network and the polyacrylate or polymethacrylate network) cannot be separated (or at least theoretically separated) without the breaking or cleavage of covalent bonds. Notably, this differs from a semi-interpenetrating polymer network, whereby one of the polymer systems is not crosslinked and can therefore be separated from the crosslinked system, at least in theory. It is expected that a skilled person would appreciate the differences between an interpenetrating polymer network (IPN) and a semi-interpenetrating polymer network (semi-IPN).

The colloidal IPN particles are advantageously suspended in an aqueous liquid. The aqueous liquid may contain, or comprise, or essentially comprise, water. It may be 100% v/v water, or it may be 99, 98, 97, 96, 95, 94, 93, 92, 91 or 90% v/v, water (i.e., it may contain, or comprise, 0, 1, 2, 3, 4, 5, 6, 7, 8, 9 or 10% v/v of another liquid). As the skilled person would appreciate, certain reactants added to the reaction mixture to form colloidal IPN particles may be formulated with, or comprise, organic solvents, the use of which may introduce a small amount of organic solvent to the aqueous colloidal suspension as an impurity. In a preferred embodiment, the aqueous liquid is at least 98% v/v water, or at least 99% v/v water, or about 100% v/v water.

The process for making an aqueous colloidal suspension of the present invention is carried out in a single vessel (that is, a ‘one-pot process’). The process broadly comprises three steps: (1) forming a polyurethane prepolymer composition; (2) neutralizing the polyurethane prepolymer composition and dispersing the neutralised prepolymer composition; and (3) forming the colloidal aqueous suspension by simultaneously forming a crosslinked polyacrylic network and a crosslinked polyurethane network. The process of the present invention is described in two alternative synthetic routes, whereby the dispersion medium of step (2) above is either water, or the non-crosslinked monomer. Each step will be described in more detail below.

### Polyurethane Prepolymer Composition

The first step of the present invention includes forming a polyurethane prepolymer composition. The prepolymers are based on urethane chemistry, meaning that they contain a diol, a polyol, and an isocyanate having at least two isocyanate groups per molecule. By ‘prepolymer’, it is meant that the result of this step is the formation of short chains of a polyurethane polymer that terminate at one end, or both ends (for a linear prepolymer) or all ends (for a branched prepolymer) with an isocyanate group (that is, the prepolymers are still reactive). These prepolymers are later extended and cross-linked in order to form a network. In this regard, this first polyurethane polymerization step is not intended to proceed to completion and form a fully cured network but rather result in a composition comprising reactive polyurethane prepolymers. A prepolymer may be defined as an intermediate molecular mass state, which are capable of further polymerization by reactive groups to form a fully cured, high molecular weight state, and which are formed from a system of monomers that have been reacted together. In other words, the skilled person would expect that a prepolymer composition would comprise reactive short-chain polymers (also referred to as NCO-terminated polymers) and may comprise unreacted components or monomers (as the reaction is stopped or slowed before completion of the polymerization reaction). Alternatively, the reaction may be controlled by having a molar excess of isocyanate-containing reactant, ensuring that NCO-terminated prepolymers are formed.

The isocyanate used in the present invention is an aliphatic isocyanate. As the skilled person would appreciate, isocyanates (that is, compounds with at least one —N═C═O group) generally belong to one of two classes, aliphatic isocyanates or aromatic isocyanates. Aromatic isocyanates are compounds whereby the isocyanate group is attached directly to an aromatic ring. For example, TDI (tolylene diisocyanates; either as 2,4-TDI or 2,6-TDI, or a mixture thereof) is a well-known aromatic isocyanate, which is based on a toluene (i.e., aromatic ring) moiety. Likewise, aliphatic isocyanates are compounds whereby the isocyanate group is attached directed to a linear or branched or cyclic aliphatic chain, which may be either saturated or unsaturated. It is also commonly known that aromatic isocyanates are more reactive than aliphatic isocyanates, however this leads to a sensitivity to water (or, more generally, moisture), whereby water can react with the aromatic isocyanates. As the polyurethane prepolymers of the present step terminate with at least one isocyanate group, and water is added before complete polymerization of the polyurethane, the highly-reactive aromatic isocyanates are not suitable for use in the present invention. The aliphatic isocyanate may have 2 isocyanate groups per molecule, or it may have 3, 4, or 5 isocyanate groups per molecule. The aliphatic isocyanate may, for example, be isophorone diisocyanate (IPDI), 1,6-hexamethylene diisocyanate (HDI), trimethylhexamethylene diisocyanate (TMDI), 4,4′-diisocyanato dicyclohexylmethane (hydrogentated MDI, or H₁₂MDI) or pentamethylene diisocyanate (PDI). In a preferred embodiment, the aliphatic isocyanate is isophorone diisocyanate (IPDI).

The diol used in the present invention may be any suitable compound that has two hydroxyl groups joined by an organic moiety. It may be an alkane diol (e.g., that is, the organic moiety may be an alkanediyl group, which may be straight chain, branched, cyclic or may have two or all of these structures). For example, it may be an alkane α,ω-diol (that is, the hydroxyl groups are at terminal carbons of the longest carbon chain of general formula HO—R—OH) in which the alkane is a straight chain alkane (i.e., it may be of general formula HO(CH₂)ₙOH, in which n may be from 2 to 12, or 2 to 10, 2 to 6, 3 to 8 or 4 to 6, e.g., 2, 3, 4, 5, 6, 7, 8, 9, 10, 11 or 12, optionally greater than 12). It may be polymeric. It may be a polyester diol, such as for example poly(tetramethylene ether) glycol (PolyTHF or PTME), or polyethylene glycol, or any other suitable polymeric glycol. Polymeric diols are commonly graded by average molecular weight, for example PTME650 may refer to a composition comprising poly(tetramethylene ether) glycol with an average molecular weight of about 650 Da. Accordingly, a polymeric diol for use in the present invention may have an average molecular weight of between about 75 and about 3000 Da, or between about 100 and about 2500, or 150 and 2000, 200 and 1500, 500 and 1000, 650 and 2000, 1000 and 3000, or 1500 and 2000, e.g., about 75, 100, 125, 150, 175, 200, 250, 300, 350, 400, 500, 550, 600, 650, 700, 750, 800, 850, 900, 950, 1000, 1100, 1200, 1300, 1400, 1500, 1600, 1700, 1800, 1900, 2000, 2100, 2200, 2300, 2400, 2500, 2600, 2700, 2800, 2900 or 3000 Da or any range therein. In a preferred embodiment, the diol is poly(tetramethylene ether) glycol, which is of general formula HO—[C₄H₈O]ₙ—H, whereby n may be between 2 and 40, such as between 2 and 10, 3 and 12, 5 and 20, 7 and 15, 10 and 30, or 20 and 40, e.g., 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40. As the skilled person would appreciate, as polymeric diols are obtained on the basis of ‘average molecular weight’, it is possible that the PolyTHF (or other polymeric diol) that is obtained and used in this step may comprise chains of more than one n value (for example, a PolyTHF composition with an average molecular weight of 225 may comprise chains with n values of 2, 3 and 4).

The polyol used in the present invention may be any suitable compound containing more than two hydroxyl groups per molecule. It may have 3, 4, 5, 6, 8, 10, 12, 15, 17, 20 or more than 20 hydroxyl groups per molecule. In some embodiments, the polyol may have 3 (a triol), 4 (a tetraol) or 5 (a pentol) hydroxyl groups. However, in the present invention, at least one of the hydroxyl groups of the polyol is substituted with an acid group, such as carboxyl (i.e., —COOH). The acid-substituted polyol of the present invention may comprise 1, 2, 3, 4, or more acid groups per molecule, each in place of a hydroxyl group. For example, an “acid substituted triol” of the present invention (and as described herein) may comprise two hydroxyl groups and one acid group (in place of the third hydroxyl group) or one hydroxyl group and two acid group (in place of the second and third hydroxyl group). In other words, although a compound may only have two hydroxyl groups, it may still be considered a ‘triol’ of the present invention if it also includes an acid group. In this regard, the acid-substituted polyol of the present invention provides dual functionality: each hydroxyl group reacts with an isocyanate group to form a urethane linkage (that is, it is incorporated into the polyurethane chain); and the at least one acid group provides a polar, ionizable site to assist with dispersion of the polyurethane prepolymer in the aqueous liquid (as described in more detail below). As the skilled person will appreciate, polyurethane chains are generally hydrophobic and tend to aggregate in polar environments (such as in aqueous liquids). However, the addition of polar ionizable pendant groups on the polyurethane chain lowers the hydrophobicity of the polyurethane chain and allows for the dispersion of the polyurethane in an aqueous liquid (also known as ‘water-borne polyurethane’). Generally, the polar pendant groups are ionizable, so that the acid group can be ionized for more effective dispersion in an aqueous liquid. For example, the acid group may be a carboxyl group, a sulphate group, a phosphate group, a nitrate group, or any other suitable ionizable acidic group. In a preferred embodiment, the acid group may be a carboxyl group and the polyol may comprise one acid per molecule. For instance, the polyol may be 2,2-bis(hydroxymethyl)propionic acid (DMPA), 2,2-bis(hydroxymethyl)butanoic acid (DMBA) or any other suitable acid-substituted polyol. In a preferred embodiment, the polyol is 2,2-bis(hydroxymethyl)propionic acid (DMPA).

The molar ratio of polyol to diol in the present invention may be about 1:1 to about 10:1, or about 5:1 to 10:1 or 3:1 to 7:1, e.g. about 1:1, 2:1, 3:1, 4:1, 5:1, 6:1, 7:1, 8:1, 9:1 or 10:1 or any range therein, based on the average molecular weight of the diol, which may be oligomeric. In a preferred embodiment, the molar ratio of polyol to diol may be between 6:1 and 8:1. Additionally, since the polyol commonly has lower molecular weight than the (usually oligomeric) diol, the weight ratio of polyol to diol may be about 0.05 to about 0.5, or about 0.2 to 0.5, 0.3 to 0.5, 0.1 to 0.4, 0.1 to 0.3 or 0.2 to 0.4, e.g. about 0.05, 0.1, 0.2, 0.3, 0.4 or 0.5 or any range therein. Preferably, the weight ratio of polyol to diol may be between about 0.1 and 0.2. More preferably, the weight ratio of polyol to diol may be about 0.15. The molar ratio of isocyanate to polyol may be between about 6:1 and 2:1, or about 5:1 and 3:1, e.g., about 6:1, 5:1, 4:1, 3:1 or 2:1 or any range therein. It follows that the molar ratio of isocyanate to diol may be between about 1:1 and 5:1, or between about 2:1 and 4:1, e.g., about 1:1, 2:1, 3:1, 4:1 or 5:1. In one preferred embodiment, the molar ratio of isocyanate to polyol may be about 4:1 and the molar ratio of isocyanate to diol ratio may be about 3:1. As the skilled person would be aware, polyurethanes generally comprise a hard segment (comprising the isocyanate species, the polyol and the chain extender) and a soft segment (comprising the usually oligomeric diol), and balancing the relative proportions of the hard and soft segments can allow the skilled person to tune the physical properties of the polyurethane. For instance, if a polyurethane has too many soft segments, it may be too flexible or pliable to be able to act as a coating; likewise, a polyurethane with too many hard segments may be too brittle or stiff to be used as a coating. In this regard, the ratio of hard to soft segments may be tuned by the skilled person to achieve the material and physical properties that are required. In one particular embodiment, the inventors have found that a molar ratio of hard segment components (i.e., the isocyanate, the polyol and the chain extender) to soft segment components (i.e., the diol) of between about 1:2 and 1:20, is particularly suitable for achieving a durable coating. Therefore, in one embodiment of the present invention, the ratio of hard segments to soft segments may be between about 1:3 and 1:10, or between about 1:5 and 1:15, or between about 1:10 and 1:20, e.g., about 1:2, 1:3, 1:4, 1:5, 1:6, 1:7, 1:8, 1:9, 1:10, 1:11, 1:12, 1:13, 1:14, 1:15, 1:16, 1:17, 1:18, 1:19 or 1:20. In one preferred embodiment, the ratio of hard segments to soft segments is between 1:3 and 1:5.

The mole ratio of isocyanate to the sum of hydroxyl groups, that is, the mole ratio of isocyanate to the total molar amount of polyol and diol, may be between about 1:1 to about 2:1, or between about 1:1 to about 1.4:1, or between about 1.2:1 to about 1.5:1, or between about 1.5:1 to about 1.8:1, e.g. about 1:1, 1.1:1, 1.2:1, 1.3:1, 1.4:1, 1.5:1, 1.6:1, 1.7:1, 1.8:1, 1.9:1 or 2:1. In one preferred embodiment, the mole ratio of isocyanate to the total molar amount of polyol and diol is about 1.4:1. The isocyanate may be present in molar excess compared to the sum of the hydroxyl groups. It may be present in a molar concentration of about 101 to about 120%, or about 101 to 110, 101 to 105, 105 to 120, 110 to 120 or 105 to 110%, e.g. about 101, 102, 103, 104, 105, 106, 107, 108, 109, 110, 115 or 120% compared to the sum of the molar concentrations of the polyol and the diol.

The polyurethane prepolymer composition of the present invention comprises a polyurethane polymerization catalyst. The polyurethane polymerization catalyst may be added to a mixture comprising an aliphatic isocyanate, a diol and a polyol. Suitable catalysts include metal-based catalysts, e.g. catalysts based on tin, bismuth, zirconium, aluminium or mixtures of any two or more of these. The catalyst may be a carboxylate, e.g. a laurate, stearate, an acetate or some other carboxylate. The metal may also be bonded to one or more (commonly two) alkyl groups e.g. a C1 to C6 alkyl group. Suitable catalysts therefore include dibutyltin dilaurate and dibutyltin diacetate. Other catalysts include tertiary amine catalysts such as 1,4-diazabicyclo[2.2.2]octane (Dabco), diazabicyclononane (DBN), diazabicycloundecane (DBU), 2,2′-bis(dimethylamino)diethylether, benzyldimethylamine, N,N-dimethylcyclohexylamine etc. In one preferred embodiment, the polyurethane polymerization catalyst may be dibutyltin dilaurate. The polyurethane catalyst may be added to a final concentration in the reaction mixture of about 50 ppm to about 500 ppm or about 100 to 300, 300 to 500 or 200 to 400 ppm, e.g. about 50, 75, 100, 150, 200, 250, 350, 400, 450 or 500 ppm. In one preferred embodiment, the polyurethane catalyst is added to a final concentration in the reaction mixture of about 100 ppm.

The resulting catalysed reaction mixture (comprising an aliphatic isocyanate, a diol, a polyol and a polyurethane polymerization catalyst) is then heated for a suitable time and at a suitable temperature for partial polymerization of the catalysed reaction mixture to occur and so form a polyurethane prepolymer composition. As the skilled person will appreciate, the suitable temperature will depend on the precise nature of the components of the catalysed reaction mixture, in particular the specific aliphatic isocyanate, diol, polyol and polyurethane polymerization catalyst being used, as well as the amount of time that the heating occurs. In this regard, the skilled person would appreciate that there may be some optimization of the temperature and reaction time, in order to produce a prepolymer composition with the desired properties (such as average molecular weight and viscosity). Typically, the temperature will be below the optimal curing temperature for a polyurethane composition, as a slower reaction rate allows for greater control over the prepolymer product. However, the temperature must not be so low as to prevent any substantial reaction from proceeding. For example, polyurethanes may commonly be cured at temperatures of between about 120° C. and about 150° C., however the catalysed reaction mixture of the present invention may be advantageously heated at a temperature of less than 120° C. For example, the temperature may be less than about 110° C., or less than about 100° C., or less than about 90° C., or less than about 80° C., or less than about 70° C., or less than about 60° C., and greater than about 50° C. It may be between about 50° C. and about 120° C., or between about 55° C. and about 110° C., or between about 60° C. and about 120° C., or between about 70° C. and about 100° C., or between about 80° C. and about 110° C., or between about 90° C. and about 100° C., or between about 50° C. and about 70° C., or between about 60° C. and about 80° C., or it may be about 50° C., 55° C., 60° C., 65° C., 70° C., 75° C., 80° C., 85° C., 90° C., 95° C., 100° C., 105° C., 110° C., 115° C. or 120° C. or any range therein. In preferred embodiments, the temperature is between 70° C. and 100° C., or about 80° C., or about 90° C. The catalysed reaction mixture may be heated from room temperature to the desired reaction temperature. The heating may occur at a rate of about 1° C./min, or about 2, 3, 4, 5, 6, 7, 8, 9, 10, 11, 12, 13, 14, 15, 16, 17, 18, 19 or 20° C. or any range therein. The catalysed reaction mixture may be held at the reaction temperature for a period of time suitable to produce a polyurethane prepolymer composition with the desired features, such as molecular weight and/or viscosity. It may be held at the reaction temperature until the reaction mixture no longer flows. The time may be between about 30 minutes and about 6 hours, such as between 30 minutes and 1 hour, between 45 minutes and 2 hours, between 1 and 4 hours, between 2 and 5 hours or between 3 and 6 hours, e.g., about 30, 35, 40, 45, 50, 55, 60 minutes or about 1, 1.5, 2, 2.5, 3, 3.5, 4, 4.5, 5, 5.5, or 6 hours, or any range therein. In one preferred embodiment, the time is between about 3 hours and about 5 hours, or about 4 hours.

Accordingly, in one preferred embodiment of the present invention, the polyurethane prepolymer composition is produced by preparing a catalysed reaction mixture. The catalysed reaction mixture comprises: isophorone diisocyanate (IPDI) as the aliphatic isocyanate; poly(tetramethylene ether) glycol (PolyTHF) as the diol; 2,2-bis(hydroxymethyl)propionic acid (DMPA) as the acid-substituted polyol; and dibutyltin dilaurate as the polyurethane polymerization catalyst, whereby: the ratio of the DMPA to the PolyTHF is between about 6:1 and 8:1; the mole ratio of IPDI to hydroxyl groups is between about 2:1 and about 4:1; and the catalyst is present at an amount of about 0.1% v/v. The catalysed reaction mixture is then heated, with stirring, to a reaction temperature of between 70° C. and 100° C. for between about 3 and 5 hours in order to form a polyurethane prepolymer composition.

### Neutralized Polyurethane Prepolymer Composition

The second step in the process of the present invention includes neutralizing the polyurethane prepolymer composition of the first step. In particular, the ionizable acidic pendant groups incorporated into the polyurethane prepolymers are treated with a base and converted into anions so that the polyurethane prepolymers are dispersible in water. For example, where the ionizable acidic pendant groups are carboxyl, these groups are converted into carboxylate ions after addition of the neutralizing agent. This step also includes the addition of a non-crosslinking acrylic monomer or water as the dispersion medium. The inventors have surprisingly found that the addition of a dispersion medium (either water or a non-crosslinking acrylic monomer) at this step reduces the occurrence of precipitates or large agglomerated particles that can form in the water-dispersible polyurethane dispersion and the water-dispersible polyurethane-polyacrylic interpenetrating polymer network. Without being bound to theory, the inventors consider that this effect is observed because the addition of a dispersion medium ensures that the neutralizing agent is well mixed within the reaction mixture before polymerisation, thus avoiding precipitation of one or both polymer systems on the addition of the other reactants.

Before addition of the neutralizing agent, the polyurethane prepolymer composition is cooled to a temperature less than the reaction temperature. The composition may be cooled to a temperature at least 5° C., or at least 10° C., or at least 20° C., or at least 30° C. or at least 40° C. below the reaction temperature. By way of example, if the reaction temperature is 80° C., the composition may be cooled to about 75° C., or about 70° C., or about 65° C., or about 60° C., or about 55° C., or about 50° C., or about 45° C., or about 40° C., or any range therein, before addition of the neutralizing agent. By way of example, if the reaction temperature is 90° C., the composition may be cooled to about 85° C., or about 80° C., or about 75° C., or about 70° C., or about 65° C., or about 60° C., or about 55° C., or about 50° C., or any range therein, before addition of the neutralizing agent. In one embodiment, the polyurethane prepolymer composition is cooled from about 80° C. to about 60° C. before addition of the neutralizing agent.

Once cooled, the neutralizing agent is added to the polyurethane prepolymer composition with stirring to form a neutralized polyurethane prepolymer composition.

The neutralizing agent may be any suitable base. It may be an organic base. It may be an amine, for example it may be ammonia. It may be an alkyl amine. It may be a trialkyl amine of general formula R₃N, whereby each R may independently be an alkyl group between 1 and 6 carbons in length (i.e., methyl, ethyl, butyl, propyl, pentyl or hexanyl). Each alkyl group may be straight chained, or it may be branched. Each alkyl group may be further substituted with at least one group selected from hydroxyl, amine or halogen. For example, it may be triethylamine (TEA) or it may be dimethylethanolamine (DMEA) or it may be any other suitable organic amine base. It may be an inorganic base, for example it may be sodium hydroxide or potassium hydroxide, or it may be any other suitable inorganic base. In one preferred embodiment, the neutralizing agent is triethylamine (TEA).

The neutralizing agent may be added in an amount suitable to ionize all of the acidic pendant groups, or substantially all of the acidic pendant groups, or at least half of the acidic pendant groups. The neutralizing agent may be in stoichiometric excess compared to the acidic pendant groups present in the prepolymer. It may be added in an amount that is 100%, or 105%, or 110% or 120% or 150% or 200% of the molar number of acidic pendant groups present in the polyurethane prepolymer or any suitable range therein.

At this step, in one reaction scheme (herein referred to as “Route I”) water is also added to form a neutralized polyurethane (i.e., NCO-terminated) prepolymer composition. The amount of water added may be sufficient to dilute the solids content of the neutralized NCO-terminated prepolymer composition by at least 5%, or at least 10%, or at least 20%, or at least 30%, or at least 40%, or at least 50%, or at least 75%, or at least 100%, or at least 150%, or at least 200%, or any range therein. As the skilled person would appreciate, the amount of water added may be optimizable, depending on factors such as the viscosity of the prepolymer composition, the reaction rate of the polymerization reactions, the molecular weight of the prepolymer and the concentration of the remaining monomers, for example. The water is added so as to provide an aqueous solvent system in which the interpenetrating polymer network can be dispersed. By aqueous, it is meant that the solvent contains, or is predominantly, or is substantially, or is at least 50%, water. In other words, the most abundant solvent during, and after, the formation of the interpenetrating polymer network is water. Although there may be other solvents present, the most abundant solvent will be water.

Alternatively, in another reaction scheme (herein referred to as “Route II”), a non-crosslinking acrylic monomer is added to the neutralized polyurethane prepolymer composition as the dispersion medium instead of water. The non-crosslinking acrylic monomer comprises only one carbon-carbon double bond. The non-crosslinking acrylic monomer may be acrylic or methacrylic. It may be for example a (meth)acrylic ester, a (meth)acrylamide, (meth)acrylic acid or some other non-crosslinking acrylic monomer (e.g. an alkoxymethacrylic ester). In a preferred embodiment, the non-crosslinking acrylic monomer is methyl methacrylate.

In either synthetic route outlined above, the polyurethane prepolymer composition is uniformly neutralised due to the addition of both the neutralizing agent and the dispersion medium.

Once the neutralizing agent and dispersion medium (either non-crosslinking acrylic monomer or water) are added, the reaction mixture may be mixed. It may be stirred. It may be kept at the temperature that it was cooled to following step a), or it may be allowed to cool to room temperature (i.e., about 20 to 25° C.), or it may be heated to a temperature of up to 120° C. The neutralized polyurethane prepolymer composition may be stirred and/or heated for a suitable period of time to ensure complete, or substantially complete, homogenization. This period of time may range from between 1 and 120 minutes, or between 5 minutes and 60 minutes, or between 20 and 80 minutes, e.g., about 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115 or 120 minutes.

### Polyacrylic System and Polyurethane Chain Extension

The third step in producing an aqueous colloidal suspension of the present invention is the formation of the acrylic polymer system and the simultaneous extension and completion of the polyurethane system. As the skilled person will appreciate, by simultaneously forming the polyacrylic polymer network at the same time as the polyurethane prepolymers are further reacted and extended into a network, the two polymer systems (i.e., polyacrylic and polyurethane systems) intercalate and can only be separated by breaking chemical bonds (that is, an interpenetrating polymer network is formed from the two polymer network systems).

In this step, a polyurethane chain extender, a crosslinking acrylic monomer and a free radical initiator are added to the neutralized polyurethane prepolymer composition, along with either water (in Route I) or the non-crosslinking monomer (in Route II). As the skilled person will appreciate and as is discussed in more detail below, the inventors understand that each polyurethane chain extender molecule reacts with the NCO-terminal groups of at least two separate polyurethane prepolymers, resulting in a single crosslinked polyurethane network, and the free radical initiator initiates the acrylic polymerization reaction, leading to each crosslinking acrylic monomer molecule reacting with two or more crosslinking or non-crosslinking acrylic monomer molecules, leading to a crosslinked polyacrylic network.

The polyurethane chain extender may be any suitable compound that is capable of reacting with the NCO-terminated polyurethane prepolymers to complete the formation of the polyurethane network. As the skilled person would be aware, polyurethane chain extenders are commonly low molecular weight compounds that react with diisocyanates to increase the molecular weight of the polyurethane and increase the block length of the hard segment. The polyurethane chain extender may comprise at least two hydroxyl groups or at least two amine groups. Commonly, polyurethane chain extenders may be any suitable diol (i.e., comprising two hydroxyl groups) or diamine (i.e., comprising two amine groups). It may be an aliphatic diol or diamine, or it may be an aromatic diol or diamine. The chain extender may be the same diol added during the formation of the polyurethane prepolymers or it may be different. The diol may be as described above. The diamine may be any suitable compound that has two amine groups joined by an organic moiety. It may be an alkane diamine (e.g., the organic moiety may be an alkanediyl group, which may be straight chain, branched, cyclic or may have two or all of these structures). For example, it may be an alkane α,ω-diamine (that is, the amine groups are at terminal carbons of the longest carbon chain of general formula H₂N—R—NH₂) in which the alkane is a straight chain alkane (i.e., it may be of general formula H₂N(CH₂)ₙNH₂, in which n may be from 2 to 12, or 2 to 10, 2 to 6, 3 to 8 or 4 to 6, e.g., 2, 3, 4, 5, 6, 7, 8, 9, 10, 11 or 12, optionally greater than 12). It may be a triamine, whereby the organic moiety comprises a secondary amine group in the chain. For example, it may be a compound of general formula H₂N—R—NH—R—NH₂, whereby both R groups may be the same alkyl chain length, or they may be different. For example, it may be diethylenetriamine (H₂N—CH₂CH₂—NH—CH₂CH₂—NH₂), dipropylenetriamine (H₂N—CH₂CH₂CH₂—NH—CH₂CH₂CH₂—NH₂) or dibutylenetriamine (H₂N—CH₂CH₂CH₂CH₂—NH—CH₂CH₂CH₂CH₂—NH₂). Alternatively, each R group may be an alkenyl chain, or an alkynyl chain, or an aryl group. Each R group may be further substituted with any suitable radical group (including, for instance, alkyl, alkenyl, alkynyl, aryl, halo, cycloalkyl, hydroxyl, carboxyl, cyano, sulfato, isocyanato, or amido). In one preferred embodiment, the polyurethane chain extender may be diethylenetriamine (DETA). The chain extender may be added in an amount that is in molar excess compared to the available isocyanate groups on the prepolymers. As the skilled person would appreciate, the available isocyanate groups on the prepolymers will be inversely related to the size of the polyurethane prepolymers: the longer the initial polymerization step (that is, the formation of the polyurethane prepolymers described above), the more isocyanate groups are reacted with a diol or polyol (leading to longer prepolymers), hence less isocyanate groups are available to react with the chain extender, and vice versa. The chain extender may be added in an amount of about 100%, or 105%, or 110% or 120% or 150% or 200% of the molar concentration of available isocyanate groups on the polyurethane prepolymers.

The crosslinking acrylic monomer comprises at least two carbon-carbon double bonds. As the skilled person would appreciate, acrylic monomers (either crosslinking or non-crosslinking) polymerize via a free radical addition reaction involving the carbon-carbon double bonds. Therefore, if an acrylic monomer has two (or more) carbon-carbon double bonds (as is the case with the crosslinking acrylic monomer required by the present invention), these monomers have two (or more) sites that may polymerize (i.e., react with another monomer). When incorporated into an acrylic polymer, such monomers introduce branching and crosslinks to other acrylate chains (hence the use of the term ‘crosslinking acrylic monomer’). In terms of the present invention, such crosslinks are necessary to produce an interpenetrating polymer network; if one of the polymer systems was not crosslinked (i.e., consisting of entirely linear or branched polymer chains without crosslinking), it would not satisfy the definition of an interpenetrating polymer network, but would be described as either a semi-interpenetrating polymer network (as defined by the IUPAC Gold Book—see https://goldbook.iupac.org/terms/view/S05598, herein incorporated in its entirety by reference) or as a polymer blend. The crosslinking acrylic monomer may be a (meth)acrylic ester or a (meth)acrylamide. In the case of an ester, it may be an ester of a diol, a triol, a tetraol, a pentaol or some other polyol, i.e. it may be a diester, triester, tetraester or pentaester etc. In the case of an amide, it may have the structure HN((═O)C—CH═CH₂)₂, N((═O)C—CH═CH₂)₃ or some other similar structure. In a preferred embodiment, the crosslinking acrylic monomer is trimethylolpropane trimethacrylate (TRIM) ([H₂C═C(CH₃)CO₂CH₂]₃CC₂H₅).

As mentioned above, and as understood by the skilled person, the acrylic monomers require a free radical initiator in order to begin polymerization. Once begun, the radical polymerization reaction self-propagates until the monomers are exhausted, or two radicals react, thereby forming a complete polymer network. The free radical initiator may be an azo initiator, an azo ester initiator, a peroxide initiator, a peroxydicarbonate initiator or some other suitable initiator. Commonly it will be a thermal initiator (i.e. one that is activated by heating), however it may in some instances be a UV-activatable initiator, a redox initiator or some other suitable initiator type. In the event that it is a thermal initiator, it may have a 10 hour half-life temperature of between about 40 to about 100° C., or about 40 to 70, 40 to 60, 50 to 80, 60 to 80, 75 to 100, 60 to 90 or 50 to 70° C., e.g. about 40, 45, 50, 55, 60, 65, 70, 75, 80, 85, 90, 95 or 100° C. It will be recognized that the half-life of an initiator may be dependent in part on the medium in which it is measured. The above 10 hour half-life temperature may be as measured in toluene, or may be as measured in the polymerization mixture. Suitable initiators include 2,2′-azobis(2-methylpropionitrile) (AIBN), 4,4-azobis(4-cyanovaleric acid), benzoyl peroxide, lauroyl peroxide and potassium persulfate. In a preferred embodiment of the present invention, the initiator is 2,2′-azobis(2-methylpropionitrile) (AIBN). The free radical initiator may be present at a mole ratio of about 2% relative to the total of non-crosslinking and crosslinking monomer. It may be present at about 0.5 to about 5%, or about 1 to 5, 2 to 5, 0.5 to 2, 0.5 to 1 or 1 to 3%, e.g., about 0.5, 1, 1.5, 2, 2.5, 3, 3.5, 4, 4.5 or 5%.

In the acrylic network, the ratio of non-crosslinking monomer to crosslinking monomer on a mole basis of polymerizable groups may be from about 10:1 to about 50:1 (i.e. about 10:1 to about 50:1, or about 10:1 to 40:1, 10:1 to 30:1, 10:1 to 20:1, 20:1 to 50:1, 30:1 to 50:1 or 15:1 to 30:1, e.g. about 10:1, 11:1, 12:1, 13:1, 14:1, 15:1, 16:1, 17:1, 18:1, 19:1, 20:1, 25:1, 30:1, 35:1, 40:1, 45:1 or 50:1. In this context, for example, if the ratio of a non-crosslinking monomer to crosslinking monomer on a mole basis were 2:1 and the crosslinking monomer had two polymerizable olefinic groups per molecule (e.g. if it were a dimethacrylate), then the ratio of non-crosslinking monomer to crosslinking monomer on a mole basis of polymerizable groups would be 1:1.

Following addition of the polyurethane chain extender, crosslinking acrylic monomer and free radical initiator, the reaction mixture is stirred. The reaction mixture may be heated (if the free radical initiator is a thermal indicator) or exposed to UV light (if the free radical initiator is a UV-activatable initiator) or some other condition that results in activation of the initiator and polymerization of the acrylic network. For instance, when AIBN is used as the free radical initiator, the reaction mixture may be heated to a temperature of between about 40 and about 100° C., or about 40 to 70, 40 to 60, 50 to 80, 60 to 80, 75 to 100, 60 to 90 or 50 to 70° C., e.g. about 40, 45, 50, 55, 60, 65, 70, 75, 80, 85, 90, 95 or 100° C. or any range therein. Advantageously, as the reaction mixture comprises water as the most abundant solvent, there is no need to pressurize the reaction vessel as the heating is carried out at or below the boiling point of the water (i.e., less than 100° C.). The reaction mixture may be held at this temperature for between about 2 and about 24 hours, or about 2 to 6, 4 to 10, 6 to 12, 5 to 15, 7 to 14, 10 to 20, or 12 to 24 hours, e.g., about 2, 3, 4, 5, 6, 7, 8, 9, 10, 11, 12, 13, 14, 15, 16, 17, 18, 19, 20, 21, 22, 23 or 24 hours or any range therein. It is anticipated that the temperature, and the time that the reaction mixture is held at this temperature, will be sufficient to ensure the complete, or substantially complete, or significantly complete, reaction of the remaining reactive components, including the acrylic monomers and the NCO-terminated polyurethane prepolymers. Accordingly, the relative temperature and time required by any specific mixture may be dependent on the reactive species present. The skilled person would be capable of optimizing these parameters. In some instances, the reaction mixture may be degassed before acrylic polymerization is initiated, so as to remove oxygen. This may be achieved by sparging, e.g., with nitrogen, helium or some other non-oxygen containing gas, or may be achieved by successive freeze-thaw cycles (e.g., 2, 3 or 4 such cycles) or by any other suitable method. In some instance the acrylic polymerization reaction may be conducted in the dark, i.e., with exclusion of visible light and/or with exclusion of UV radiation, optionally with exclusion of all electromagnetic radiation.

The polyurethane prepolymer composition, as well as, independently, the neutralized polyurethane prepolymer composition or the aqueous colloidal suspension, may have a solids content of from about 5 to about 50% w/v, or from about 5 to 40, 10 to 30, 10 to 20, 30 to 50, or 7 to 15%, e.g. about 5, 6, 7, 8, 9, 10, 12, 14, 16, 18, 20, 22, 24, 26, 28, 30, 32, 34, 36, 38, 40, 42, 44, 46, 48 or 50%. In this context, “solids content” refers to the weight of all materials other than the solvent in 100 ml of solution. Thus “solids” may in fact not be in solid form.

### Coating

Once the polymerization reactions are completed, an interpenetrating polymer network has been formed. The interpenetrating polymer network may be in the form of a dispersion of particles dispersed in the aqueous solvent, whereby the particles comprise, or consist of, an interpenetrating polymer network. It may be a colloidal dispersion. The particles of the dispersion may have a mean particle diameter of from about 200 to about 1000 nm, or from about 200 to 500, 500 to 1000 or 300 to 700 nm, e.g., about 200, 250, 300, 350, 400, 450, 500, 550, 600, 650, 700, 750, 800, 850, 900, 950 or 1000 nm. In some cases, it may be smaller, e.g., down to about 10 nm. It may be for example about 10 to about 200 nm, or about 10 to 100, 10 to 50, 20 to 200, 50 to 200, 100 to 200, 20 to 50 or 50 to 100 nm, e.g., about 20, 30, 40, 50, 60, 70, 80, 90, 100, 150 or 200 nm. The particles may be monodispersed or may be polydispersed. They may have a broad or a narrow particle size distribution. The ratio of weight average to number average particle diameters may be between about 1 and about 10 or greater, or about 1 to 5, 1 to 2, 2 to 10, 5 to 10 or 2 to 5, e.g. about 1, 1.5, 2, 2.5, 3, 3.5, 4, 4.5, 5, 6, 7, 8, 9 or 10. It will therefore be understood that the dispersion comprises, or contains, a cured interpenetrating polymer network in the form of colloidal particles dispersed in an aqueous solvent. When this is applied to a surface, the aqueous solvent can evaporate and the colloidal interpenetrating polymer network particles can adhere to the surface and each other, leaving a coated surface having microroughness due to the shape and size of the adhered colloidal particles. In this regard, the skilled person would understand that this process is not the curing of the polymers on the surface in order to form a two-polymer system (whether an interpenetrating polymer network, or semi-interpenetrating polymer network, or polymer blend), but rather the drying and subsequent adherence of colloidal particles, comprised of, or containing, the cured interpenetrating polymer network, on a surface so as to form a film or coating.

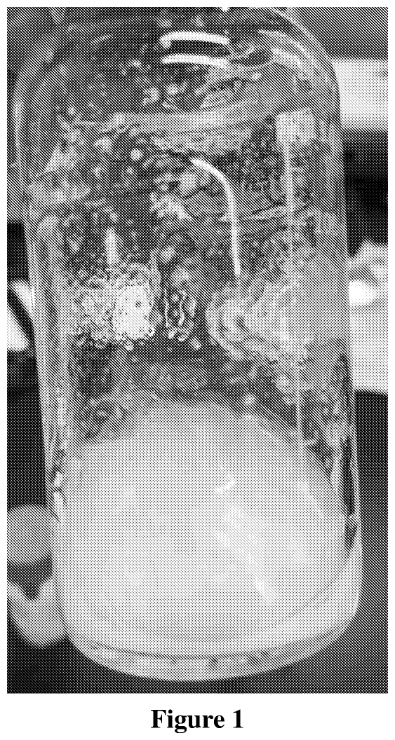

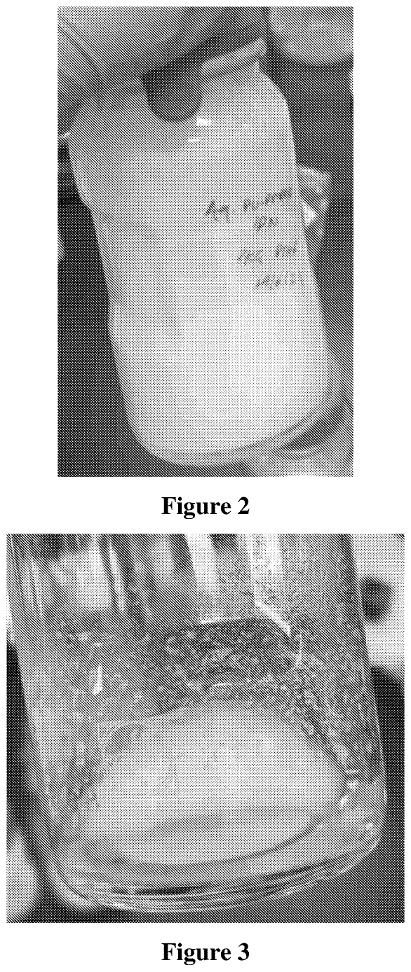

Advantageously, the colloidal dispersion of the present invention is both stable and sprayable. The inventors have found that the specific order, timing and amounts of reactants being used (as described above) can affect the size of the dispersed particles and the overall stability of the dispersion and, importantly, whether or not the obtained dispersion is sprayable, or whether larger agglomerations are obtained that would preclude the use of spraying apparatus to apply the dispersions. For instance, if the non-crosslinking acrylic monomer is added in the third step (i.e., with the crosslinking acrylic monomer and the free radical initiator) instead of the second step, the resulting dispersion forms large agglomerations and is not sprayable (see examples below and FIGS. 1 and 2). The inventors understand that the present invention represents the first reporting of a stable, sprayable aqueous PU-PMMA IPN dispersion, which is a significant technical hurdle that has now been addressed by the present invention.

The dispersion may be free, or substantially free, of large particles (such as precipitation by-products) that may block the spraying device. The dispersion may also be of a suitable viscosity so as to allow for even spraying without excessive pressures being required. For instance, it may have a viscosity less than about 1000 cP, or less than about 500, 200, 100 or 50 cP. Accordingly, the colloidal dispersion may be applied to a surface by spraying, using any suitable device or apparatus. In one embodiment, the colloidal dispersion is applied using an artist's airbrush at a pressure of between about 2 and 4 bar, or preferably at about 3 bar and a distance of between about 15 and 25 cm, or about 20 cm, from the surface. However, these variables may be optimised, depending on the particular features of the colloidal suspension to be sprayed. Although the colloidal dispersion is able to be sprayed, other methods of applying it to a surface may also be suitable. For example, methods such as wiping, rolling, spin-coating, dip-coating, drop-casting, electrospinning, or some other suitable method, may also be used.

Once applied to a surface, the colloidal dispersion may be allowed to dry so as to form a coating or film on a surface. The time to dry will depend on a range of conditions, including (but not limited to) the thickness of the coating, the presence of other solvents (other than water), and the relative humidity and temperature of the drying. The drying may be conducted at any suitable temperature. It will commonly be conducted at ambient temperature, e.g. between about 20 and 25° C., but may be conducted at elevated temperature, e.g. about 25 to about 80° C., or about 25 to 50, 25 to 35, 35 to 60, 40 to 70, or 50 to 80° C. It may for example be conducted at about 20, 25, 30, 35, 40, 45, 50, 55, 60, 65, 70, 75 or 80° C. Suitable conditions are 20-25° C. and 40-60% relative humidity. It is expected that the drying conditions will be optimisable by the skilled person. It is preferred that the coating dries under ambient conditions.

The surface may be any suitable surface. It may be a metallic surface, a polymeric surface, a wooden surface, a glass surface, a ceramic surface, a synthetic surface or some other surface, or a combination of any two or more of these surfaces. The resulting dried film may function as a protective coating. It may function as a base coat for further coating layers.

In one embodiment, after partial drying of the coating, a particulate material may be applied to the coating. It may for example be sprayed onto the coating. The particulate material will be applied as a suspension, or it may be applied as dry particles. The suspension may be in a volatile solvent or it may be in an aqueous solvent. The concentration of the particulate material in the suspension may be about 1 to about 10% w/v, or about 1 to 5, 1 to 2, 2 to 10, 5 to 10 or 2 to 5%, e.g., about 1, 2, 3, 4, 5, 6, 7, 8, 9 or 10%. The particulate material may be applied to the coating a period of time after the colloidal suspension has been applied to the surface to form a coated surface. The period of time may be between about 10 and 100 minutes, or it may be between about 10 and 40 minutes, or between about 40 and 60 minutes, or between about 50 and 75 minutes, or 70 to 100 minutes, e.g., about 10, 15, 20, 25, 30, 35, 40, 45, 50, 55, 60, 65, 70, 75, 80, 85, 90, 95 or 100 minutes. The time should be sufficient for partial drying but preferably insufficient for complete drying of the coating. Following application of the particulate solid, the resulting composite solid may be allowed to dry completely. In this context “completely” indicates a residual solvent content of less than about 5% by weight, or less than about 4, 3, 2 or 1% by weight. Without being bound by theory, it is thought that the hydrophobic particles provide nanoroughness to the surface of the film, which, in combination with the microroughness due to the colloidal particles, provides superhydrophobicity to the coating.

The particulate material may be a particulate solid. It may have a mean particle size of about 2 to about 20 nm, or about 2 to 10, 2 to 5, 5 to 20, 10 to 20 or 5 to 10 nm, e.g. about 2, 3, 4, 5, 6, 7, 8, 9, 10, 11, 12, 13, 14, 15, 16, 17, 18, 19 or 20 nm. It may be an inorganic particulate solid. Particles of the particulate solid may have organic regions and inorganic regions. The particulate solid may be hydrophobic. It may be a ceramic. It may be titania. It may be iron oxide. It may be a hydrophobic ceramic, e.g., hydrophobic silica. It may be a silica having grafted organic groups on the surface of the particles thereof. It may be a fumed silica, e.g. a hydrophobic fumed silica. Mixtures of any two or more of these particles may also be used. It may be a fumed silica having hydrophobic groups on the surface. The hydrophobic groups may be alkyl groups, e.g., C1 to C18 straight chain or branched alkyl groups, such as methyl, ethyl, n-propyl, i-propyl, n-butyl, t-butyl, hexyl, octyl, isooctyl, decyl, dodecyl, tetradecyl or hexadecyl. They may be fluoroalkyl groups, e.g., perfluoroalkyl groups. They may be fluorinated or perfluorinated or partially perfluorinated forms of any of the alkyl groups described above. Any two or more of the above hydrophobic groups may be present. For example, the fumed silica may have fluoroalkyldialkylsilyloxy groups on the surface. The alkyl groups may be any of the alkyl groups described above, and the fluoroalkyl group may be any of the fluoroalkyl groups described above. For example, the particulate solid may comprise fumed silica having 1H,1H,2H,2H-perfluorooctyldimethylsiloxy groups on the surface thereof. It should be noted that “1H,1H,2H,2H-perfluorooctyl” refers to F₃C(CF₂)₅(CH₂)₂—. The organic groups may be present on substantially the entire surface of the particles. The hydrophobic particulate solid, when applied to the film, may be partially wetted by the polymer mixture or it may be completely wetted by the polymer mixture. The particles of the particulate solid may be wetted over a part of their surface. The particulate solid may be wetted before curing and/or drying of the polymers such that, when cured, the hydrophobic solid is partially, or at least partially, embedded in the surface of the film. The embedded particles may be abrasion resistant. The embedded particles may be partially embedded in the surface of the film and partially exposed to the surrounding environment or they may be fully embedded in the surface of the film. In embodiments where the particulate solid is partially embedded in the coated surface, it is expected that at least a portion of the particulate solid is directly accessible at the surface (i.e., the particulate solid is not fully wetted and surrounded by the coated surface).

The suspension of the particulate material and the dispersion of the interpenetrating polymer network particles may each be stable. They may, independently, be stable for at least about 1 week or at least about 2, 3, 4, 5, 10, 15, 20, 25, 30, 35, 40, 45, 50 or 52 weeks or more. In one embodiment, the dispersion of the present invention is stable for at least 12 months. As the skilled person would appreciate, environmental conditions such as temperature and humidity, as well as factors such as the material of the vessel for storage or light sources, for example, can affect the stability of formulations during storage. In this context, the term “stable” indicates that after the stated storage period, at room temperature (i.e., between about 15 and 25° C.) and relative humidity of between about 10% and about 60%, the concentration of particles in the top half of the dispersion differs from the concentration of particles in the bottom half of the dispersion by less than about 10%, or less than about 8, 6, 4, 2 or 1%, when the dispersion is stored without agitation, that is, the dispersion remains homogenous, or is substantially homogeneous. As the skilled person would appreciate, if the temperature and/or relative humidity were decreased, it would be expected that the dispersion would remain sprayable after more than at least 12 months; likewise, if the temperature and/or relative humidity were increased, the dispersion may not remain stable up to 12 months. For the avoidance of doubt, it is expected that the aqueous dispersions of the present invention can be stored under laboratory conditions, at room temperature and variable relative humidity, in a glass container and exposed to light, for at least 12 months and still be sprayable after this storage period.

The resulting composite film may therefore comprise an interpenetrating polymer network, and may have a surface layer comprising the particulate solid. In this context, the “surface layer” may be the top 20% of the film, or the top 10%, or the top 5% or the top 2%. The surface layer may comprise both the interpenetrating polymer network and the particulate solid. It may comprise the particulate solid at least partially embedded in the interpenetrating polymer network. The composite network may be hydrophobic. It may be superhydrophobic. It may be a lotus effect surface. It may exhibit Cassie-Baxter wetting characteristics. It may have a WCA of at least about 150°, or at least about 155, 160 or 165°, e.g., about 150, 155, 160, 165 or 170° C. It may have a sliding angle of less than about 20°, or less than about 15, 10 or 5°, e.g., about 5, 10, 15 or 20°. It may be capable of maintaining these values after abrasion. It may be capable of maintaining these characteristics after at least 50 abrasion cycles, or after at least 60, 70, 80, 90, 100, 150, 200, 250, 300, 400, 500, 750, or 1000 abrasion cycles. These may be as defined in ASTM D4060. It may be capable of maintaining these characteristics after at least 1000 minutes of UV exposure at 354 nm and 3.3 mW/cm², or at least about 1500, 2000, 2500 or 3000 minutes. It may be capable of maintaining these characteristics after at least 6 hours of immersion in a strong mineral acid, or at least 12, 18 or 24 hours. It may be capable of maintaining these characteristics after at least 6 hours of immersion in oil, or at least 12, 18 or 24 hours. The film may be substantially transparent to visible light at a thickness of up to 1 mm. It may have transmittance at 600 nm of at least about 50%, or at least about 55, 65 or 70%. The film may have a thickness of from about 10 to about 50 microns (micrometres), or about 10 to 30, 20 to 50, 20 to 30 or 20 to 40 microns, e.g., about 10, 15, 20, 25, 30, 35, 40, 45 or 50 microns. The thickness of the film may be measured by any suitable means known in the art, such as a handheld coating thickness gauge or the like.

The superhydrophobic films of the present invention may be used in any application in which superhydrophobicity is a benefit and/or where abrasion resistance and/or durability is a benefit. For example, they may be used to reduce drag coefficient in water craft, or to reduce marine fouling, or to reduce corrosion of bodies, especially metallic bodies, immersed in water. They may also be used as coatings on electronics, solar panels, on glass surfaces to reduce droplet adhesion (e.g., for windscreens), in medical equipment, for rendering surfaces self-cleaning and in other applications. The superhydrophobic films of the invention form a useful protective coating to substrates to provide improved resistance to abrasion and to chemical insults. Advantageously, the films or coatings of the present invention provide at least the same, or improved, mechanical and chemical characteristics when compared to coatings produced with organic solvents, even though the organic solvent(s) have been replaced with water.

In a particular embodiment, the invention relates to a stable, aqueous PU-PMMA colloidal IPN system that self-assembles during spray deposition into a hierarchically structured ultra-robust coating. This IPN coating serves as a platform for superhydrophobic nanostructures enabling preservation of a highly dewetting Cassie-Baxter state through mechanical-, chemical- and photo-induced stresses. These superhydrophobic coatings preserved a pristine lotus-dewetting surface (WCA>150°, SA<10°) after 250 rotary abrasion cycles, finger-wipe resilience, extended immersion in concentrated acids and oil contamination as well as extended high intensity UVC exposure. Furthermore, the composite interfaces possess excellent optical properties with 14.8% net transmittance losses. The findings provide an easily applicable PU-PMMA IPN platform with superior mechanical and chemical properties for the synthesis of highly durable and transparent self-cleaning coatings, an enabling step for many real-world applications.

Described herein is a method for producing highly durable, sprayable superhydrophobic coatings, based on microscale and nanoscale texturing whereby the microscale texturing is provided by the colloidal interpenetrating polymer network particles, and the nanoscale texturing is provided by a hydrophobic particulate solid. The sprayable coatings are prepared in aqueous solution, eliminating the need for volatile organic compounds of known methods, resulting in a more cost-effective and safer process whilst achieving a coating with durability and physical properties that are at least equivalent to coatings produced with volatile solvents.

### EXAMPLES

The present invention will be described below, with reference to examples that are provided for illustration only; it is not intended that the present invention be limited solely to the examples provided herein.

As mentioned above, it has been advantageously found that a stable, sprayable APUA IPN dispersion can be formed by either a) adding water and the neutralizing agent to the NCO-terminated polyurethane prepolymer (i.e., Route I synthesis); or b) adding the non-crosslinkable acrylic monomer with the neutralizing agent, separately to the other acrylic system reactants, as the medium in which the NCO-terminated pre-polymers are dispersed (i.e., Route II synthesis), as summarised in Scheme 1 below.

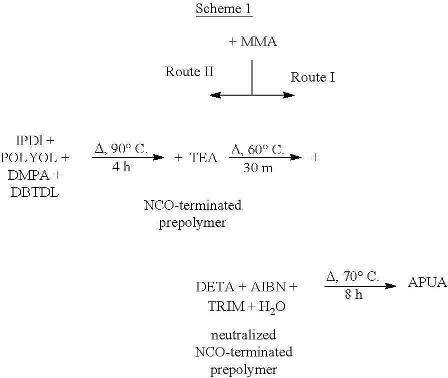

Adding the non-crosslinkable acrylic monomer separately to the other acrylic components, or adding water to effectively dilute the NCO-terminated polyurethane prepolymers, is understood to decrease the precipitates or agglomerations that are formed. It is believed that this is due to the complete neutralisation of the polyurethane NCO-terminated prepolymers that is possible when a dispersion agent (either water or the non-crosslinking acrylic monomer) is added before addition of the reactive polymerisation reagents. For comparison, see FIG. 1 (a PU-PMMA IPN system formed without the use of a dispersion medium) and FIG. 2 (a PU-PMMA IPN system with the non-crosslinkable acrylic monomer added as a dispersion medium with neutralizing agent, before addition of the water and remaining acrylic reagents). Without being bound by theory, it is expected that these agglomerations are caused by one of the polymer network systems (likely the polyurethane system) forming faster than the other polymer system (likely the acrylic system) and hence forming large particles. The inventors note that the same phenomenon was seen with just the aqueous polyurethane system, without the addition of the acrylic system (see FIG. 3), suggesting that the co-forming acrylic system keeps the colloidal particles to a dispersible size, so long as the non-crosslinking acrylic monomer is dispersed amongst the polyurethane prepolymers before polymerization, which can be achieved either by use of the non-crosslinking monomer as the dispersing medium, or adding water to slow the kinetics of the parallel polymerisation reactions. Examples of these synthesis routes and the characterisation of them, are provided below for illustrative purposes.

### Example 1—Aqueous Colloidal Dispersion (Route I Synthesis)

To synthesize an aqueous based IPN dispersion comprising a polyurethane network and a polyacrylic network (that is, a PU-PMMA IPN dispersion), one general example includes mixing isophorone diisocyanate (IPDI, Sigma-Aldrich), 2,2-Bis(hydroxymethyl)propionic acid (DMPA, Sigma-Aldrich), polytetramethylene ether glycol (POLYOL, Sigma-Aldrich, Mn=2000) and dibutyltin dilaurate (DBTDL, Sigma-Aldrich, 95%) and reacted together at 80° C. to obtain NCO-terminated prepolymers which is then cooled to 60° C. and triethylamine (TEA, Sigma-Aldrich) is added to neutralize the ionic centres. Then water is added as a dispersion medium to this neutralized NCO-terminated prepolymer, followed by the addition of chain extender diethylenetriamine (DETA, Sigma-Aldrich) and PMMA precursors methyl methacrylate (MMA, Sigma-Aldrich, 99%), trimethylolpropane trimethacrylate (TRIM, Sigma-Aldrich, 90%) and 2,2′-azobis(2-methylpropionitrile) solution (AIBN, Sigma-Aldrich, 0.2M in toluene) to obtain the aqueous PU-PMMA IPN dispersion.

As the skilled person would appreciate, it is the molar ratios of the various reactants that are of most relevance to the stability of the aqueous suspension and properties of the film or coating of the present invention. In this example, the inventors have found that optimal relative molar ratios of each of the abovementioned reactants are: IPDI:POLYOL of between about 8:1 and about 9:1; IPDI:DETA of between about 1.5:1 and about 3:1; IPDI:DMPA of between about 3:1 and about 4:1; and DMPA:POLYOL of between about 2:1 and about 3:1. The inventors have found that colloidal particles dispersed in an aqueous solvent and comprising, or consisting of, a PU-PMMA IPN, when produced using the process of the present invention and in the concentrations and relative proportions described above, remain well dispersed and stable at room temperature and do not result in the congregation of larger particles that would not be suitable for spraying. This stability has been observed over extended periods of time, with samples of the aqueous suspension still being sprayable about 1 year after formulation.

### Example 2—Aqueous Colloidal Dispersion (Route II Synthesis)

In another method for synthesizing an aqueous-based IPN dispersion comprising a polyurethane network and a polyacrylic network (that is, a PU-PMMA IPN dispersion) an isocyanate terminated pre-polymer was first prepared in a 100 mL round bottom flask by reacting 3.34 g of hard-segment constituting isophorone diisocyanate (IPDI, Sigma-Aldrich, 98%) with 3.74 g of pre-melted soft-segment imparting polytetramethylene ether glycol (POLYOL, Sigma-Aldrich, average Mn=2000) and 0.54 g of hydrophilic carboxyl group containing 2,2-Bis(hydroxymethyl)propionic acid (DMPA, Sigma-Aldrich, 98%) in the presence of the catalyst dibutyltin dilaurate (DBTDL, Sigma-Aldrich, 95%). The reaction was allowed to proceed for 4 hours at 90° C. under a constant stirring rate of 500 rpm. An equivalent molar concentration of triethylamine (TEA, Sigma-Aldrich, >99%) was then added to the reaction mixture to neutralise all carboxylic acid groups in addition to adding methyl methacrylate (MMA, Sigma-Aldrich, 99%) as a dispersion medium to obtain flow viscosity. The reaction was allowed to proceed to 60° C. until all solids were visually dissolved to obtain a neutralized NCO-terminated prepolymers. Further, 0.91 g of polyurethane cross-linker diethylenetriamine (DETA, Sigma-Aldrich, 99%), 0.24 g of PMMA cross-linker trimethylolpropane trimethacrylate (TRIM, Sigma-Aldrich, 90%), 0.12 g of PMMA initiator 2,2′-azobis(2-methylpropionitrile) solution (AIBN, Sigma-Aldrich, 0.2 M in toluene) and 80 mL of deionized water as dispersion medium were added to the reaction mixture. The reaction mixture is kept for 8 hours to 70° C. under a constant stirring rate of 500 rpm to obtain a 90 mL batch of a sprayable aqueous based IPN dispersion with a solids content of 15%.

Notably, the molar ratio of components in this synthesis method are the same as described above for the Route I synthesis.

### Example 3—Characterisation

The resulting dispersions from the two synthesis methods were further characterised, as discussed below.

### Coating

In an initial test, the aqueous dispersion obtained via Route I as described above was sprayed using an artist's airbrush onto a 3 cm×3 cm glass surface. In particular, 1.2 mL of the aqueous dispersion was sprayed, at a pressure of 3 bar and a distance of 20 cm from the substrate. The sprayed coatings were retained on the surface after a finger wipe test (i.e., the applied dispersion was not removed by manual wiping shortly after application) indicating that the dispersion had strongly adhered to the glass surface. It also visually appears similar to the compositions achieved previously with VOC-based solvent systems (such as those described in WO 2017/193157).

As the skilled person would appreciate, a major challenge surrounding the use of aqueous paints and adhesives is the wettability of substrates during the coating process. Conventional solvent-borne PU-PMMA systems do not induce substrate wetting due to the use of highly volatile organic compounds which evaporate at a much faster rate with an enthalpy of vaporization (ΔHᵥₐₚ) for acetone=31 kJ mol⁻¹ and for xylene=42 kJ mol⁻¹ at standard temperature and pressure (SATP) compared to the ΔHᵥₐₚ of water=44 kJ mol⁻¹ for aqueous poly(urethane-acrylate) systems. Further, using Raoult's law, the vapor pressure of acetone-xylene mixture yields a value of 19.58 kPa at SATP which is 600% higher than the vapor pressure of water with a value of 3.17 kPa indicating the significantly higher evaporation rate in solvent-borne PU-PMMA system. In addition, the ambient relative humidity of 30-50% further hinders the evaporation of waterborne dispersions compared to solvent-borne systems. The inventors have found that excessive substrate wetting may be mitigated by establishing an equilibrium between sprayable colloid deposition and evaporation of the dispersion medium, which ensures prevention of fluid build-up on the substrate. The use of spray guns and nozzles for coating fabrication in combination with optimized spray parameters help prevent substrate wetting by maintaining a fine droplet size while ensuring coating durability.

### Spray Optimization—Abrasion Analysis

As cured APUA coatings demonstrated complete wetting with water, spray volume and spray distance were optimized by investigating the variation in abrasion induced optical properties in lieu of water contact measurements.

Durability of the APUA coatings was assessed for varying spray volume and spray distance by subjecting the coated samples to a hard rotary platform abrasion tester based on the ASTM D4060 Taber standard with two CS-10 wheels (12.7 mm width, 51.7 mm diameter, Calibrase, U.S.A) and 250 g loading on each grinding wheel. The samples were allowed to abrade for up to 800 abrasion cycles at a rate of 60 rpm with optical properties determined at three different locations of the abraded wear track for quantitative analysis of abrasion damage. A compressed air stream was used to remove the residual material before each measurement at pre-determined intervals of 0, 100, 200, 400, and 800 abrasion cycles while a vacuum was used to constantly remove dust and debris during abrasion. The optical transmission and haze values were determined with a TH-100 haze meter (CHNSpec Technology, China) according to ASTM D 1003 standard in lieu of conventional weight loss as a function of Taber abrasion cycles due to the considerable variation of deposited material resulting from the varying spray parameters.

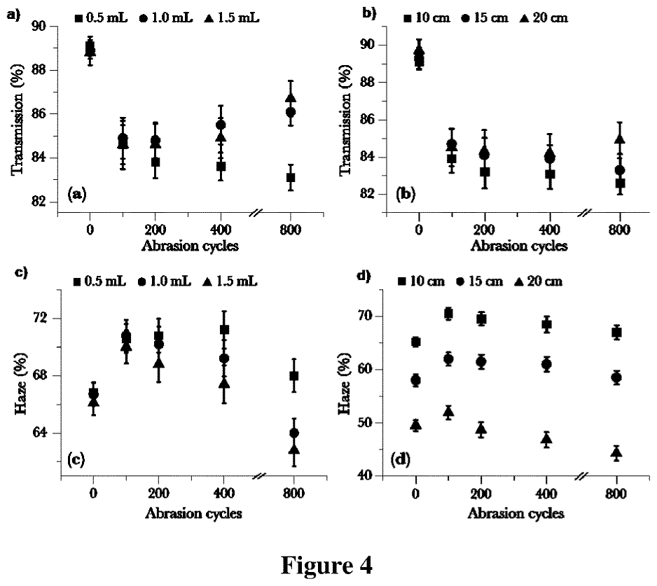

As the skilled person would appreciate, optical transmission is defined as the percentage of light which passes through a sample while haze is the measurement of fraction of light dispersed at an angle of greater than 2.5° from the incident source as it passes through an object. Optical transmission and haze values of the APUA coatings were plotted as a function of hard abrasion at pre-determined intervals of 0, 100, 200, 400, and 800 abrasion cycles, see FIG. 4. As can be seen, an initial decrease in optical transmission of APUA coatings is observed up to 100 cycles indicating the increased surface roughness due to abrasion induced surface damage which is further supported by the increased haze values in the same range. As the abrasion is continued up to 800 cycles, an increase in optical transmission is observed with a simultaneous decrease in haze values indicating exposed glass substrate resulting from abrasion induced coating removal, see FIGS. 4(a) and 4(c). Further, the spray volume and spray distance optimization plots indicate low variation in transmission and haze values for 0.5 mL spray volume and 10-15 cm spray distance post 100 cycles of hard abrasion in comparison to 1.0-1.5 mL spray volume and 20 cm spray distance which exhibit an increased transmission and decreased haze at 800 cycles compared to 100 cycles due to the removal of damaged coating. This was anticipated as it is understood that the increase in spray volume increases the surface roughness, resulting in higher number of wear sites while increasing the spray distance result in the formation of thinner coatings which both make the coatings susceptible to increased abrasion damage. The reduced coating thickness with increasing spray distance is further indicated by the 1% increase in optical transmission and 15% decrease in haze of unabraded coatings fabricated at a spray distance of 20 cm compared to 10 cm, see FIGS. 4(b) and 4(d).

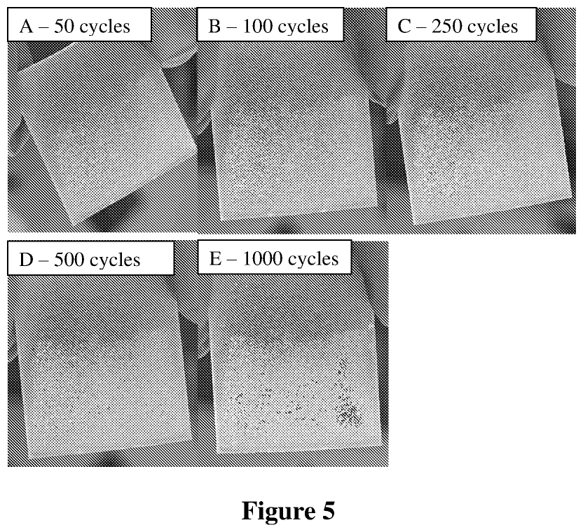

The comparatively high durability performance of spray coated APUA coatings, fabricated using optimized parameters with a spray distance of 10 cm, a spray volume of 0.5 mL, and subjected to 1000 cycles of hard cyclic abrasion is demonstrated in FIG. 5. Qualitatively, the results of this test shows that the coatings formed from the aqueous-based PU-PMMA IPN dispersions remained intact until at least 250 cycles, with some small degradation visible at 500 cycles and substantial degradation occurring at 1000 cycles, although a small patch of coating material was visibly removed after 1000 cycles (see bottom right hand corner of sample E in FIG. 5) which is indicative of the initiation of coating failure. However, this result is in line with the more common VOC-based IPN coatings.

### Spectroscopic Analysis

To investigate the successful transition from solvent-borne PU-PMMA IPN system (as described in WO 2017/193157 A1) to the aqueous poly(urethane-acrylate) APUA system, comparative spectroscopic analysis was performed for uncured dispersions and cured coatings of both systems.

As the skilled person would appreciate, Fourier transform infrared spectroscopy (FTIR) techniques such as transmission, reflection, and attenuated total reflection (ATR) are commonly used in the investigation of polyurethane formation, presence of hydrogen bonding in urethane and urea-based formulations, and to investigate the reaction kinetics of a system. The chemical composition and successful synthesis of the APUA system was investigated by comparative analysis of uncured suspensions and cured coatings for APUA and solvent-borne PU-PMMA IPN systems using FTIR in attenuated total reflection mode (FTIR-ATR, with a diamond crystal, Bruker-Alpha, U.S.A). All measurements for uncured samples were obtained by drop casting the colloidal suspension on the ATR crystal while for cured samples a spray deposited sample was prepared on a 25×25 mm microscopic glass slide using an artist's airbrush spray gun (0.3 mm, nozzle diameter) with a spray pressure of 3 bar, spray distance of 10 cm, spray angle of 90°, and spray volume of 0.5 mL for each formulation while ensuring 24 hours of curing time to evaporate all solvents and stabilize intrapolymer stresses prior to taking measurements. A control spin-coated sample was prepared to study roughness induced artefacts for spray coated samples with no noticeable difference observed in the spectroscopic analysis. Further, time-based investigation of APUA reaction system was performed by obtaining the spectroscopic information of cured samples at pre-determined intervals with the initial time at 0 h indicating the formation of neutralized NCO-terminated pre-polymer, and addition of water, PU cross-linker and remaining PMMA precursors. Measurements were taken at intervals of 0 h, 2 h, 4 h, and 8 h, with FTIR spectra plotted for APUA-0 h, APUA-2 h, and APUA-8 h samples due to the similarity of the data obtained for 2 h and 4 h samples. Each signal was captured using 24 scans in 400-4000 cm⁻¹ range and each sample was scanned for three times. The spectroscopic data was plotted and analysed in OriginPro 2020b.

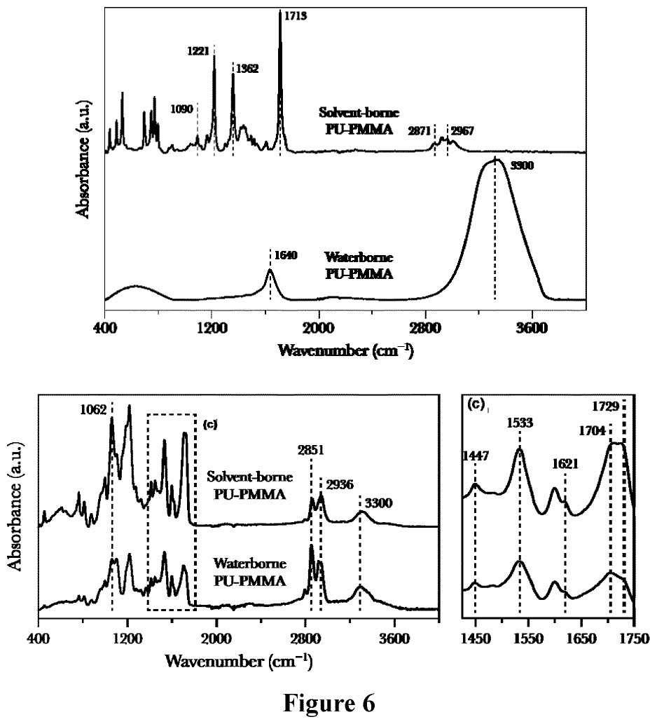

The distinctive peaks for uncured dispersions characteristic of solvents used and the similarity of peaks for the cured coatings characteristic of urethane, acrylate, and urea linkages in addition to the presence of hydrogen bonding indicate the successful synthesis of APUA system, see FIG. 6(a). It is worth noting that for cured coatings although the formation of NCO-terminated pre-polymer and the presence of catalyst DBTDL accelerates urethane bond formation and limits the isocyanate-water side reaction, the presence of diamine chain extender result in significant urea linkage formation arising from the isocyanate-amine reaction. Further, the bifurcated hydrogens of urea have strong affinity to form high strength ordered hydrogen bonding at room temperature which is indicated by the shift of free carbonyl and N—H stretching vibrations to lower wavenumbers due to hydrogen bonding induced C—O and N—H bond weakening with shifts as high as 150 cm⁻¹ previously reported. Comparing the uncured dispersions of the two systems, the solvent-borne PU-PMMA dispersion exhibits the characteristic peaks of acetone and m-xylene as indicated by the 2967 cm⁻¹ CH₃ asymmetric stretching vibration, 2871 cm⁻¹ CH₃ symmetric stretching vibration, 1713 cm⁻¹ carbonyl (C—O) stretching vibration, 1362 cm⁻¹ CH₃ symmetric deformation, 1221 cm⁻¹ CCC asymmetric stretching vibration, and 1090 cm⁻¹ CH₃ rocking vibration. In contrast, the uncured aqueous poly(urethane-acrylate) based dispersion exhibits the characteristic peaks of water as indicated by a broad 2900-3700 cm⁻¹ region with a peak at 3300 cm⁻¹ corresponding to O—H stretching vibration and a 1640 cm⁻¹ peak corresponding to hydrogen bonded O—H bending vibration.

In comparison, the cured coatings of solvent-borne and APUA systems exhibit high similarity with the characteristic peaks for urethane and urea appearing in the regions from 3150-3500 cm⁻¹ for —NH stretching vibrations, 2700-3000 cm⁻¹ for C—H stretching vibrations, and 1600-1800 cm⁻¹ for C—O stretching vibrations, see FIGS. 6(b) and (c). For APUA system, the characteristic peaks for urethane appear at 1729 cm⁻¹ indicating the free carbonyl (C═O) stretching vibration, and 1533 cm⁻¹ for amide II (N—H) bending vibration while the presence of hydrogen bonded urea and urethane linkages is indicated by the H-bonded N—H stretching vibration at 3300 cm⁻¹ with a very weak shoulder peak at ~3500 cm⁻¹ corresponding to the free N—H stretching vibrations, a double peak in the 1700-1730 cm⁻¹ region with a peak at 1704 cm⁻¹ corresponding to H-bonded carbonyl (C—O . . . H—N) stretching vibration located in close proximity to 1729 cm⁻¹ free carbonyl peak, and a peak at 1621 cm⁻¹ indicating high strength ordered hydrogen bonded carbonyl (C—O . . . N—H) stretching vibration of urea with a peak shift of 66 cm⁻¹ from 1687 cm⁻¹ for free carbonyl stretching of urea. In addition, the disappearance of 2255 cm⁻¹ IPDI isocyanate peak for APUA system and 2235 cm⁻¹ N—C—O stretch of TDI for solvent-borne system indicate the complete conversion of isocyanate to urethane and urea. Further, the presence of PMMA in the system is indicated by overlapping C—H stretching vibrations at 2936 cm⁻¹, free carbonyl C—O stretching peak at 1729 cm⁻¹, C—H bending vibrations at 1447 cm⁻¹, and the 1062 cm⁻¹ peak characteristic of PMMA chain formation. All characteristic peaks for both solvent-borne PU-PMMA and aqueous poly(urethane-acrylate) systems for uncured dispersions and cured coatings are given in Table 1.

TABLE 1
Comparative analysis of vibrational frequencies for conventional solvent-borne PU-
PMMA and aqueous poly(urethane-acrylate) systems for both uncured dispersions and cured
coatings. All vibrational frequencies are in v^{~} (cm⁻¹) and obtained experimentally using FTIR.

| | | | |
|---|---|---|---|
| Assignment | Solvent-borne IPN | APUA IPN | Literature |

Uncured dispersions

| | | | |
|---|---|---|---|
| O—H stretch | — | 3300 | 2800-3800 |
| CH₃ asymmetric stretch | 2967 | — | 2967-2972 |
| CH₃ symmetric stretch | 2871 | — | 2860-2879 |
| C—O stretch | 1713 | — | 1700-1725 |
| O—H bend, hydrogen bonding | — | 1640 | 1640-1645 |
| CH₃ symmetric deformation | 1362 | — | 1360-1366 |
| CCC asymmetric stretch | 1221 | — | 1215-1228 |
| CH₃ rocking | 1090 | — | 1090-1098 |

Cured coatings

| | | | |
|---|---|---|---|
| N—H stretch, hydrogen bonded | 3307 | 3300 | 3260-3340 |
| CH₃ asymmetric stretch | 2944 | 2936 | 2935-2945 |
| CH₂ symmetric stretch | 2859 | 2851 | 2850-2860 |
| C—O stretch, free | 1725 | 1729 | 1720-1740 |
| C—O stretch, hydrogen bonded | 1711 | 1704 | 1703-1710 |
| C—O, ordered H-bonded urea | 1621 | 1621 | 1620-1645 |
| N—H bend | 1533 | 1533 | 1522 |
| CH₂, CH₃ bend | 1447 | 1447 | 1446 |
| C—N stretch | 1413 | 1413 | 1382-1410 |

The solvent-borne and APUA systems also exhibit some notable differences including: (i) proportion of hydrogen-bonded urea (1621 cm⁻¹) to hydrogen-bonded urethane (1704 cm⁻¹) linkages, (ii) proportion of hydrogen-bonded urethane (1704 cm⁻¹) to free urethane (1729 cm⁻¹) linkages, and (iii) proportion of methylene (2851 cm⁻¹) to methyl groups (2936 cm⁻¹) in the system.

Further tests were carried out using the aqueous dispersion described above (as obtained via Route II) which was then sprayed using an artist's airbrush onto the surface of a 25 mm×25 mm glass microscopic slide. In particular, 0.5 mL of the aqueous dispersion was sprayed, at a pressure of 3 bar, spray angle of 900 and a distance of 10 cm from the substrate, before being left to cure for 24 hours to evaporate all solvents and stabilize the intrapolymer stresses prior to taking measurements. A control spin-coated sample was prepared to study roughness induced artefacts for spray coated samples with no noticeable difference observed in the spectroscopic analysis.

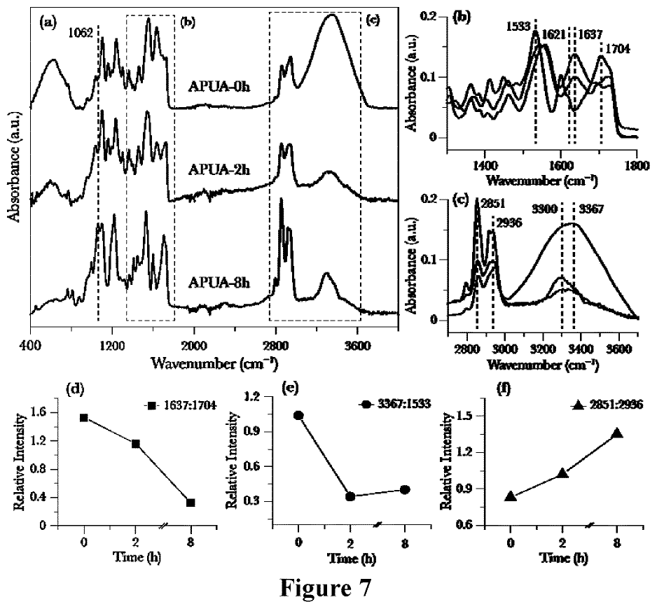

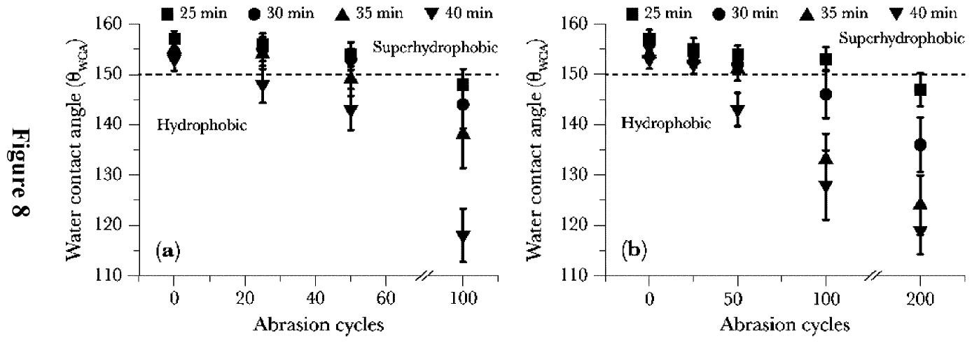

To further understand the chemical composition of aqueous poly(urethane-acrylate) system and its similarity with the solvent-borne PU-PMMA cured system, time-based reaction kinetics were studied by obtaining the spectroscopic information at different time intervals of 0 h, 2 h, 4 h, and 8 h with the corresponding naming convention APUA-0 h, APUA-2 h, APUA-4 h, and APUA-8 h, respectively. The initial time, t=0 h, indicates the time corresponding to the formation of neutralized NCO-terminated pre-polymer and addition of PU chain extender diethylenetriamine, PMMA initiator AIBN and cross-linker TRIM, and dispersion medium deionized water. Due to the similarity between spectroscopic information obtained for APUA-2 h and APUA-4 h samples, the FTIR spectra were plotted and analysed for APUA-0 h, APUA-2 h, and APUA-8 h, see FIG. 7(a). It was observed that the appearance of strong 1062 cm⁻¹ peak for APUA-8 h sample corresponding to PMMA backbone skeletal rocking indicate complete MMA polymerization upon reaction completion. The delay in PMMA formation is attributed to the presence of hydroquinone monomethyl ether (MEHQ) in the MMA monomer which acts as an inhibitor delaying the conversion of MMA to PMMA. Further, three main regions exhibit distinct variation in peaks for urethane and urea formation as time progresses. These are: (i) 1300-1800 cm⁻¹ region corresponding to carbonyl stretching vibrations, (ii) 2900-3700 cm⁻¹ region corresponding to N—H stretching vibrations, and (iii) 2800-3000 cm⁻¹ region corresponding to C—H stretching vibrations, as discussed below.
1. C—O region: Polyurethanes demonstrate strong carbonyl absorption bands in the range between 1610-1760 cm⁻¹ depending on the hydrogen bonding capacity. For aqueous poly(urethane-acrylate) system, the interpretation of carbonyl region is challenging due to the simultaneous addition of diamine and water after neutralized NCO-terminated pre-polymer formation with both diamine and water demonstrating high reactivity with isocyanates. The complexity further increases due to the presence of ternary amine (TEA) which catalyses the isocyanate-alcohol reaction and the presence of which accelerates urethane formation. Furthermore, isocyanate and water readily react at room temperature even in the absence of a catalyst resulting in the formation of carbamate linkages, whereas addition of primary amine (DETA) results in considerably higher reaction rate between isocyanate-amine compared to isocyanate-water. The broad carbonyl peak from 1610-1680 cm⁻¹ with a maximum intensity at 1637 cm⁻¹ for both APUA-0 h and APUA-2 h samples indicate the presence of ordered hydrogen bonded urea in the system which is attributed to the amine-isocyanate reaction and the formation of intermediary carbamate linkage resulting from the isocyanate-water side reaction. However, due to the presence of more nucleophilic diethylenetriamine in the system in addition to the formation of broad and bulky polymer chains, it is understood that carbamate linkages rearrange into new urethane or urea compounds via transcarbamoylation as indicated by the disappearance of 1637 cm⁻¹ peak, appearance of ordered hydrogen-bonded urea peak at 1621 cm⁻¹ peak, and increase in the relative intensity of hydrogen bonded urethane peak at 1704 cm⁻¹ compared to free urethane peak at 1725 cm⁻¹, see FIGS. 7(b) and (d). The thermal stability of isocyanate-based urea is greater than urethane linkage which further explains the dissociation of carbamate group as DETA is added to the reaction system. The shift to lower wavenumber for ordered hydrogen-bonded urea and increase in hydrogen-bonded urethane is attributed to the growing polymer network and cross-linking between PU and PMMA resulting in higher strength hydrogen bonding leading to restricted vibrational motions registered by a lower absorbed frequency.
2. N—H region: The addition of diethylenetriamine at t=0 h is indicated by the presence of a broad and intense peak at 3367 cm⁻¹ corresponding to free amine stretching vibrations for the APUA-0 h sample in addition to the C—N stretching vibrations at 1199 cm⁻¹ and N—H stretching vibration at 889 cm⁻¹, see FIG. 7(c). In contrast, the comparatively narrow and significantly reduced peak intensity for APUA-8 h at 3300 cm⁻¹ indicates the utilization of chain extender DETA to produce hydrogen bonded amide linkages via amine-isocyanate reaction. In addition, the shift of 3367 cm⁻¹ peak for APUA-0 h to 3330 cm⁻¹ for APUA-2 h and 3300 cm⁻¹ for APUA-8 h in combination with the shift of 1558 cm⁻¹ for APUA-0 h to 1541 cm⁻¹ for APUA-2 h and 1533 cm⁻¹ for APUA-8 h further indicates the increasing strength of hydrogen bonding in the aqueous poly(urethane-acrylate) system as reaction progresses. Furthermore, the slightly higher value of amide linkages at reaction completion is indicative of increased amide groups per unit volume resulting from the increased chain length and increased cross-linking in the system, see FIG. 7(e).
3. C—H region: The C—H stretching vibrations appear in the region between 2800-3000 cm⁻¹ The appearance of multiple peaks in the region indicate the presence of both methyl (CH₃) and methylene (CH₂) groups in the APUA system with the peaks at 2918 cm⁻¹ and 2851 cm⁻¹ corresponding to CH₂ asymmetric and symmetric stretching vibrations, respectively while the peak at 2936 cm⁻¹ correspond to the CH₃ asymmetric stretching with CH₃ symmetric stretching vibration peak masked by the high intensity CH₂ peaks. The presence of methyl groups in the system is further confirmed by the 1370 cm⁻¹ C—H bend peak in addition to the peak at 1447 cm⁻¹ corresponding to the overlapping C—H bending vibrations for both methylene and methyl groups. Time-based reaction analysis indicate the increase of symmetric methylene stretching vibration compared to asymmetric methyl stretching vibration with time, see FIG. 7(f). The increasing CH₂ groups per unit volume of the APUA formulation with time indicate the chain extension and cross-linking in the system leading to the formation of interpenetrated long chains of polyurethane and PMMA. In addition, the appearance of methylene asymmetric stretching vibration peak at 2918 cm⁻¹ as reaction progresses further indicates the presence of CH₂ long chain molecules in the system.

### Example 4—Superhydrophobic Performance

To assess the superhydrophobic performance of aqueous poly(urethane-acrylate) system, a layer of a low surface energy fluorinated silica nanoparticle suspension was sequentially spray deposited on the curing APUA surface. An optimized curing time of 20 min at SATP conditions is reported for solvent-borne PU-PMMA system, however, for APUA system superhydrophobic state was not observed for coatings fabricated using a curing time of 20 min due to the delayed evaporation of water and penetration of F—SiO₂ nanoparticles in the still-wet APUA layer. Therefore, the superhydrophobic performance of aqueous poly(urethane-acrylate) system was investigated by varying the cure time of APUA layer from 25-40 min with a regular interval of 5 min. In addition, durability of the APUA-F—SiO₂ superhydrophobic coatings was evaluated by measuring the water contact angle (θ_{W CA}) of the abraded surface post hard and soft abrasion.

It was observed that for all samples with APUA curing time between 25-40 min, the surface demonstrated a superhydrophobic state with an initial θ_{W CA} greater than 150° indicating that a minimum cure time of 25 min is essential to obtain APUA-based superhydrophobic coating. Further, the sample with the 25 min cure also demonstrated a superhydrophobic Cassie-Baxter state for up to 100 cycles of hard cyclic abrasion and 200 cycles of soft cloth rub linear abrasion with deteriorating performance observed for increasing cure time, see FIG. 8. The high performance of 25 min sample in lieu of the expected superior performance of samples with longer curing time due to high ΔHᵥₐₚ of water, results from the 300% reduction in the optimized spray volume for APUA system compared to conventional solvent-borne PU-PMMA system resulting in optimized curing at reduced time.

### Example 5—Comparative Example

In order to demonstrate that not all aqueous dispersions of a polyurethane/polyacrylic IPN are sprayable, the inventors have produced an aqueous dispersion as disclosed in Yan, et al. (2017) Journal of Materials, Processing and Design, Vol 1, No. 1, pp. 1-9 (herein incorporated by reference in its entirety).

In this comparative example, the inventors have prepared a pre-polymer composition in an aqueous environment based on the method of Yan et al. (albeit with some like-for-like substitutions due to chemical unavailability). In this method, the following steps were carried out to form a pre-polymer polyurethane composition, with the only variations being the use of 1,1,1-tris(hydroxymethyl)propane (in place of the Polyether 310) and dimethylolpropionic acid (in place of dimethylolbutanoic acid), which the inventors consider to be suitable chemical substitutions:
(a) IPDI (an aliphatic di-isocyanate) was added to a mixture of Polyether 218 (a diol), 1,1,1-tris(hydroxymethyl)propane (a triol) and dimethylolpropionic acid (a polyol with one acid group) and heated with stirring to a temperature above 85° C. for 4 hours; then
(b) After heating, the reaction mixture was lowered to 70° C. and hydroxyethyl acrylate (a non-crosslinking monomer) was added before stirring continuously for 1 hour, before addition of ethylenediamine (a chain extender) then triethylamine (an alkyl amine) and water to a final solids content of 25%.

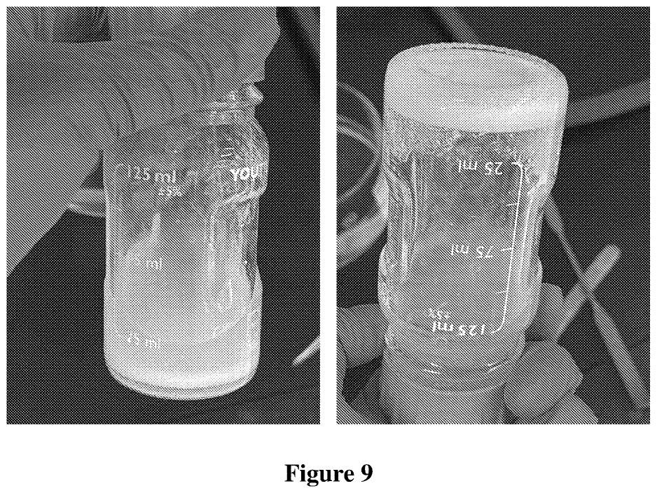

The formulation resulted in a very hard gel settled at the bottom of the reaction vessel, which the inventors were unable to remove or disperse in either hydroxyethyl acrylate or water as suggested in the method of Yan et al. Shown in FIG. 9 are pictures of the gelled pre-polymer with the upside-down Schott bottle clearly exhibiting the undispersed pre-polymer. As is evident from these results, the composition of Yan et al. would not be sprayable (which is an advantage of the present invention).

The inventors attribute this hard gelation to the addition of TRIOL in the very first step of the reaction which results in network formation leading to gelation. Based on their experience, the inventors conclude that the gelled precursors form precipitates that are unable to be dispersed, which is observed here. The inventors also note that this is a similar result to that discussed above in relation to FIGS. 1 to 3, whereby the simultaneous acrylic polymerization and polyurethane chain extension decreases the aggregation and gelling of the polyurethane system, leading to the dispersion seen in FIG. 2.

This comparative example further demonstrates that the order of addition of the reactants, and in particular the inclusion of a dispersion medium with the neutralising agent to ensure complete neutralisation of the polyurethane prepolymer before polymerisation of the polymer systems, is important to the formation of a sprayable, aqueous dispersion of particles comprising an interpenetrating polymer network, and that not all mixtures comprising urethane reactants and acrylate reactants will inherently be capable of forming a sprayable dispersion.

This comparative example further validates the ease of synthesis of the aqueous PU-PMMA dispersion described herein.

Although the invention has been described with reference to specific examples, it will be appreciated by those skilled in the art that the invention may be embodied in many other forms in particular features of any one of the various described examples may be provided in any combination in any of the other described examples. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A process for making a sprayable aqueous colloidal suspension, wherein the colloidal suspension comprises an interpenetrating polymer network and the interpenetrating polymer network comprises a polyurethane network and a polyacrylic network, the process comprising the steps:
a) preparing a polyurethane prepolymer composition by mixing, at a reaction temperature between about 50° C. and about 120° C.:
i. an aliphatic isocyanate having at least two isocyanate groups per molecule;
ii. a diol;
iii. a polyol having at least one acid group per molecule; and
iv. a polyurethane polymerization catalyst;
b) cooling the polyurethane prepolymer composition to a temperature less than the reaction temperature and then adding an alkyl amine and a dispersion medium to form a neutralized polyurethane prepolymer composition, wherein the dispersion medium is selected from water or a non-crosslinking acrylic monomer; then
c) adding to the neutralized polyurethane prepolymer composition, with mixing:
i. water if the dispersion medium of step b) is a non-crosslinking acrylic monomer, or a non-crosslinking acrylic monomer if the dispersion medium of step b) is water;
ii. a polyurethane chain extender;
iii. a crosslinking acrylic monomer; and
iv. a free radical initiator
to form the aqueous colloidal suspension.

2. The process of claim 1, wherein the aliphatic isocyanate is an aliphatic diisocyanate.

3. The process of claim 2, wherein the aliphatic diisocyanate is isophorone diisocyanate (IPDI).

4. The process of any one of claims 1 to 3, wherein the polyol is a triol, tetraol or a pentaol and at least one hydroxyl group has been substituted with an acid group.

5. The process of any one of claims 1 to 4, wherein the polyol has one carboxylic acid group per molecule.

6. The process of claim 5, wherein the polyol is 2,2-bis(hydroxymethyl)propionic acid (DMPA).

7. The process of any one of claims 1 to 6, wherein the diol is an oligomeric or polymeric diol.

8. The process of claim 7, wherein the diol is a poly(tetramethylene ether) glycol.

9. The process of any one of claims 1 to 8, wherein the polyurethane catalyst is dibutyltin dilaurate.

10. The process of any one of claims 1 to 9, wherein the alkyl amine is a trialkylamine.

11. The process of claim 10, wherein the trialkylamine is triethylamine (TEA).

12. The process of any one of claims 1 to 11, wherein the polyurethane chain extender is a diamine, a triamine or a tetramine.

13. The process of claim 12, wherein the triamine is diethylenetriamine (DETA).

14. The process of any one of claims 1 to 13, wherein the non-crosslinking acrylic monomer is an acrylate ester or a methacrylate ester.

15. The process of claim 14, wherein the non-crosslinking acrylic monomer is methyl methacrylate.

16. The process of any one of claims 1 to 15, wherein the crosslinking acrylic monomer is a diol di(meth)acrylate, a triol tri(meth)acrylate, a tetraol tetra(meth)acrylate or a pentaol penta(meth)acrylate.

17. The process of claim 16, wherein the crosslinking acrylic monomer is trimethylolpropane trimethacrylate (TRIM).

18. The process of any one of claims 1 to 17, wherein the free radical initiator is 2,2′-azobis(2-methylpropionitrile) (AIBN).

19. The process of any one of claims 1 to 18, wherein:
the molar ratio of the aliphatic isocyanate to the polyol having at least one acid group per molecule is between 2:1 and 6:1, or about 4:1; and
the molar ratio of the aliphatic isocyanate to the diol is between 1:1 and 5:1, or between about 2:1 and 3:1, or about 3:1; and
the more ratio of the non-crosslinking monomer to the crosslinking monomer is between 10:1 and 50:1.

20. The process of any one of claims 1 to 19, wherein the reaction temperature is between about 70° C. and about 100° C., or is about 90° C.

21. The process of claim 20, wherein the temperature of step b) is less than or about 60° C.

22. The process of any one of claims 1 to 21, further comprising:
a waiting time of between about 2 hours and about 6 hours between step (a) and step (b); and/or
a waiting time of between about 10 minutes and about 1 hour between steps (b) and step (c), and/or
a waiting time of between about 4 hours and about 24 hours after step (c).

23. A process for making a coating comprising an interpenetrating polymer network, the process comprising the steps of:
a) spraying the aqueous colloidal suspension of any one of the preceding claims on to a surface to produce a coated surface; and
b) applying a particulate solid to the coated surface, wherein substantially the entire surface of the particulate solid is hydrophobic.

24. The process of claim 23, wherein the applying is by spraying.

25. The process of claim 23 or 24, further comprising a period of time between applying the aqueous colloidal suspension to produce a coated surface and applying a particulate solid to the coated surface.

26. The process of claim 25, wherein the period of time is between 10 and 100 minutes.

27. The process of any one of claims 23 to 26, wherein the particulate solid is at least partially embedded in the coated surface.

28. A coating produced from the process of any one of claims 23 to 27.
